(19) United States
(12) Patent Application Publication
(10) Pub. No.: US 2015/0379411 A1
(43) Pub. Date: Dec. 31, 2015

(54) CONTENT RECOMMENDATION SELECTION AND DELIVERY WITHIN A COMPUTER NETWORK BASED ON MODELED PSYCHOLOGICAL PREFERENCE STATES

(71) Applicant: Regents of the University of Minnesota, Minneapolis, MN (US)

(72) Inventors: Komal Kapoor, Minneapolis, MN (US); Jaideep Srivastava, Plymouth, MN (US); Paul Schrater, Minneapolis, MN (US)

(21) Appl. No.: 14/732,288

(22) Filed: Jun. 5, 2015

Related U.S. Application Data
(60) Provisional application No. 62/008,274, filed on Jun. 5, 2014.

(51) Int. Cl. G06N 5/04

(52) U.S. Cl. CPC G06N 5/04

(57) ABSTRACT

Creation and various uses of an example model of preferences that displays certain types of time and history dependent dynamics are disclosed. Creation and use of the model may be based on insights from studies in human psychology and gained from the exploration of real world temporal preference data. Particularly, the dynamics of satiation for familiar content are incorporated in the model by dynamic item preference states. In some examples, the model may identify different latent preference states for items which are called the Sensitization, the Boredom, and the Recurrence states. Dynamics in a user's preferences for items may be attributed to the dynamics in these item states.

This application claims the benefit of U.S. Provisional Patent Application No. 62/008,274, filed Jun. 5, 2014, the entire contents of which are incorporated herein by reference.

### BACKGROUND

Today's users of computers have access to large bodies of content from numerous content providers and service providers. For instance, through the Internet, users may be able to listen to thousands of different audio tracks, watch thousands of different movies, read millions of books, news articles, blog entries, or other written content, view millions of pictures, purchase billions of different products, or otherwise consume a variety of different types of content. In many instances, the content may be varied in type, genre, subject matter, style, and/or in other ways.

When consuming content, a user typically manually select content items in which they are interested. For example, the user may choose which songs he or she wants to listen, which news stories he or she wants to read, which movies or television shows he or she wants to watch. Users generally select content items for consumption based on current desires or preferences at the time of selection. Such desires or preferences, however, often fluctuate over time, causing the user to manually select different content.

### SUMMARY

Techniques are described for defining and representing psychological preference states of users with respect to consumption of current content items, such as the state of satiation (boredom) with particular content, the state for exploration and novelty seeking when users desire new content. These underlying models for psychological states are then applied to drive specific programmatic applications within a computer network. In one specific application, a computer system is described that provides automated, state-dependent recommendations to users for media or other content based on the uniquely modelled psychological preference states for that user at a current time. For example, in the state of boredom certain types of content are not recommended and in the state of exploration particular new items may be recommended.

In general, conventional recommendation models solely use past user choices to infer their preferences, which form the basis for making future recommendations. Changing preferences is significant challenge for these methods, requiring continuous preference tracking to allow for temporal changes in preferences such as shifts in user interests using time weighting and drift functions. However, typical approaches are unable to model the process of evolution of preferences with time and as a result of the past user choices. For example, spontaneous de-valuation or boredom due to repeated exposure to stimuli is a well-known phenomenon in human psychology, as is spontaneous return of preference. Existing models have no mechanism for tracking such effects of exposure to the same content or similar content on future preferences.

In this disclosure, techniques are described that explicitly model preferences to display certain types of time and history dependent dynamics, using insights from studies in human psychology and gained from the exploration of real world temporal preference data. The dynamics of satiation for familiar content are explicitly addressed by proposing for the first time a dynamic item preference state model. These unique models are then applied to specific applications in automated or semi-automated recommendation and delivery of content within computer networks.

In one implementation, the model identifies different latent preference states for items which are called the Sensitization, the Boredom and the Recurrence states. Dynamics in a user's preferences for items are attributed to the dynamics in these item states. Empirical validation for the modeling techniques are provided by analyzing music listening data from Last.fm. Further, the model, together with a specification for its dynamics constitutes a comprehensive framework that provides unprecedented capabilities for modeling the temporal needs of the users. Pragmatically, this allows better state-dependent recommendations to be generated for the users. The utility of the modeling techniques is also presented for designing exploratory recommenders.

In one example, user psychological preference states can be used for designing media content recommenders. These recommenders generate a small sample of personalized content which is preferentially shown to the user.

In another example, the psychological preference states can also be used to identify disengaged users-users which are not finding content in accordance to their preference states. These users can then be targeted with strategies to engage them again.

### BRIEF DESCRIPTION OF DRAWINGS

FIG. 1 is a block diagram illustrating an example preference state analysis system in accordance with one or more techniques of the present disclosure.

FIG. 2 is a block diagram illustrating a detailed example of various devices that may be configured to implement some embodiments in accordance with one or more techniques of the present disclosure.

FIG. 3 is a flow diagram illustrating example operations for media recommendation using psychological preference states in accordance with one or more techniques of the present disclosure.

FIG. 4 is a block diagram illustrating an example user dynamic state transition model.

FIG. 5 is a table describing problems in modeling user preferences addressed by the techniques described herein.

FIGS. 6A-6D are graphs illustrating example hazard rates for content users.

FIGS. 7A-7B are graphs illustrating example survivor functions for a content user's exit time.

FIGS. 7C-7D are graphs illustrating example survivor functions for a content user's entry time.

FIGS. 8A-8D are graphs illustrating example survivor and exit hazard functions.

FIG. 9 is a block diagram illustrating an example of the dynamic interaction between user preferences and user choice of content.

FIG. 10A is a block diagram illustrating an example of the Dynamic State Hypothesis model.

FIG. 10B is a block diagram illustrating an example of the Bayesian model.

FIG. 11A is a conceptual diagram illustrating an example dynamic item preference state model.

FIG. 11B is a conceptual diagram illustrating the dynamics between the preference states.

FIGS. 12A-12B are graphs illustrating an example hazard function.

FIGS. 13A-13C are conceptual diagrams illustrating example hazard functions.

FIG. 14 is a conceptual diagram illustrating an example hazard function.

FIGS. 15A-15B are graphs illustrating an example State Conditioned Dynamic Preference Model.

FIG. 16 is a conceptual diagram illustrating an example dynamic item preference state model.

### DETAILED DESCRIPTION

Techniques of the present disclosure enable a computing system or other computing device to model dynamic user preferences and/or leverage such a model in a variety of specific applications, such as content recommendation, content placement or organization, user retention, interest prediction, and others. For instance, the computing system may incorporate history and time dependent changes in user preferences to generate a model of users' preference states by analyzing data indicating past behavior and experiences of one or more users. Additionally or alternatively, the system may apply a user preference state model to the actions of a particular user in order to predict the particular user's preference state, recommend content for the particular user based on the particular user's preference state, predict a service or content provider's retention of the particular user, or perform other automated or semi-automated programmatic operations.

By generating and/or utilizing a model of user preferences that incorporates the dynamic nature of human desires, even with respect to the same or similar content currently being consumed by the user, the techniques described herein may improve capabilities for modeling the temporal preferences of a user and applying those modeled preference to specific applications. For example, the techniques of the disclosure may enable a computing system to generate a more accurate representation of human preferences, provide better state-dependent recommendations for content delivery within a computer network, and/or determine more accurate predictions of user retention for a network-based service.

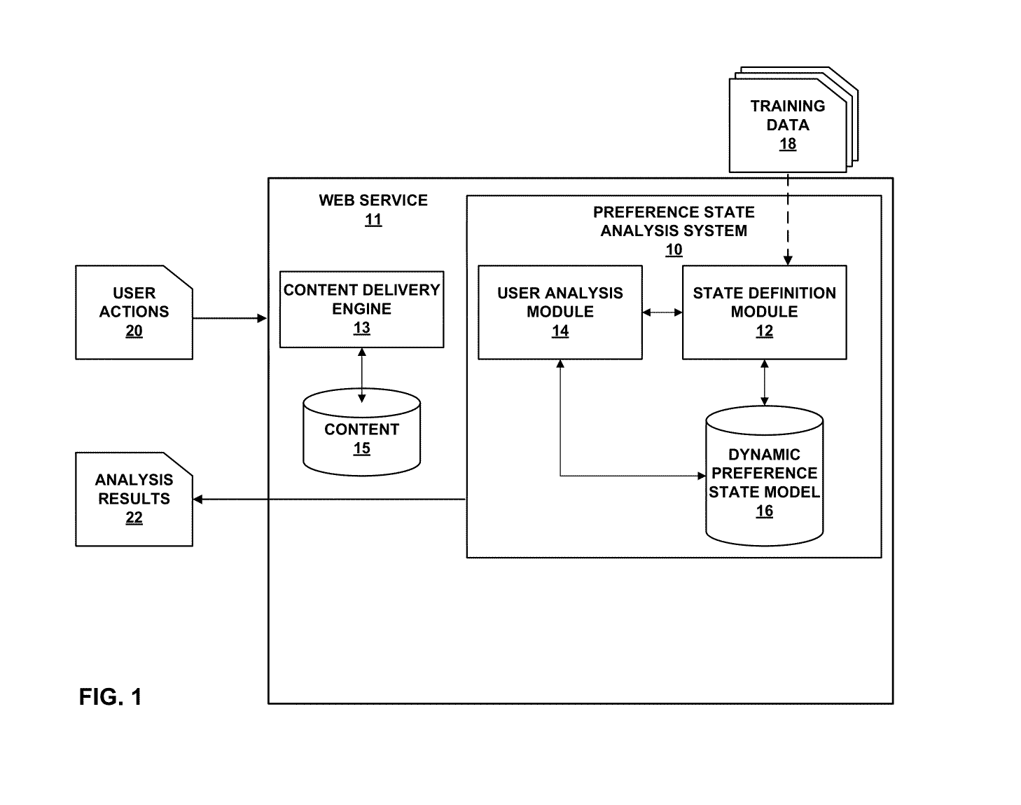

FIG. 1 is a block diagram illustrating an example computing environment in which a web service 11 (e.g., web site or content provider) includes a content deliver engine 12, a content repository 13 (e.g., database) of content items, and a preference state analysis system 10 (“system 10”) in accordance with one or more techniques of the present disclosure. In general, content delivery engine 13 retrieve and communicates content items to users over a computer network. In the example of FIG. 1, system 10 represents a computing device or computing system having a plurality of computing devices, such as servers, virtual machines, data centers, mobile computing devices (e.g., a smartphone, a tablet computer, and the like), desktop computing devices, distributed computing systems (e.g., a “cloud” computing system), or any other device capable of performing the techniques described herein.

As shown in the example of FIG. 1, system 10 includes state definition module 12, user analysis module 14, and dynamic preference state model 16. Each of modules 12 and 14 may be hardware, firmware, software, or some combination thereof. Dynamic preference state model 16 may, in the example of FIG. 1, represent a data structure or other collection of information that is accessible and/or modifiable by one or more of modules 12, 14.

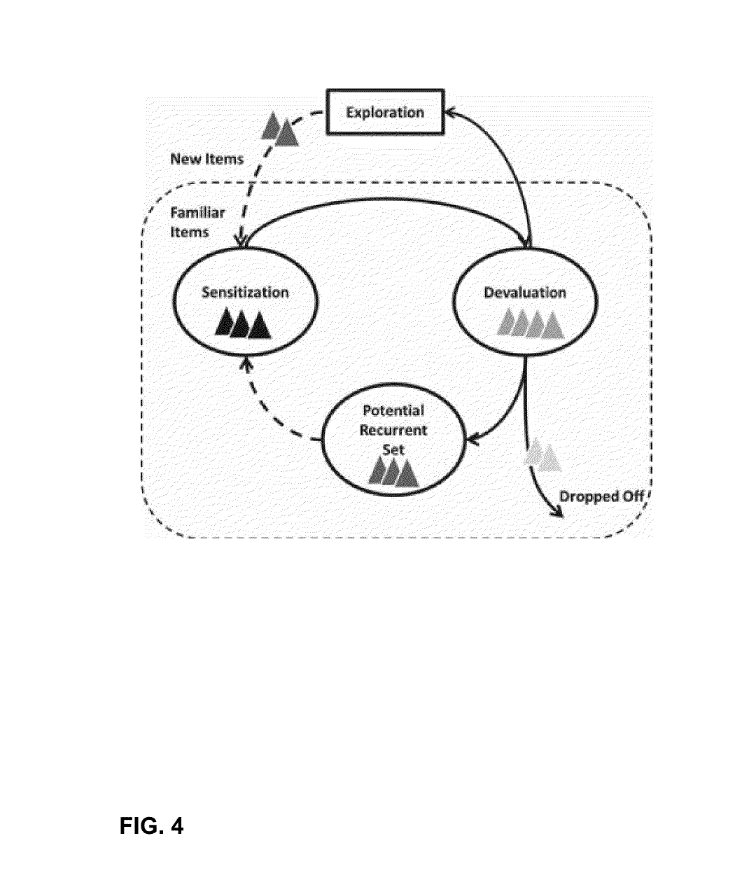

Dynamic preference state model 16, in the example of FIG. 1, may represent an overall framework for user preferences that incorporates the history- and time-dependent dynamics existing in an organism's decision making processes. As described in further detail below, dynamic preference state model 16 may, in one example, comprise a plurality of preference states in which available content items (e.g., news stories accessible to the user via a news service, songs available to the user from a music service, and the like) are divided into two disjoint sets: “Familiar items” and “New items.” Furthermore, as described herein, familiar items may be further subdivided into preference states based on each item's previous exposure to the user. As described in more detail below, FIG. 4 illustrates a conceptual transition model for the defined preference states of state definition model 12 and illustrates how the different sets of content items may be treated in the various states.

In the example of FIG. 1, one or more components of system 10 (e.g., state definition module 12) may utilize training data 18 to define and/or calibrate dynamic preference state model 16. Training data 18 may be a set of data indicating previous actions of one or more users. For instance, training data 18 may be data indicating users' music listening selections over time, including song names, artist names, and timestamps from an online music service, as described below with respect to measuring spontaneous devaluations in user preferences. Further examples of training data 18 may include product purchasing habits over time, news content access habits over time, or other indications of user consumption of content items.

State definition module 12 may utilize the framework defined herein to create and/or calibrate dynamic preference state model 16. For instance, state definition module 12 may utilize a hazard rate function to define a conditional probability of exit and a conditional probability of entry. The creation and calibration of dynamic preference state model 16 is further described below with respect to diversity in recommendations using psychological preference states for items. For instance, state definition module 12 may utilize training data 18 to determine one or more probability functions that provide state-dependent consumption rates, (Cᵢ(t)) for an item i for a user u with the elapsed time for a state given its frequency of consumption f. Examples of determined model functions are provided below as equations (9) and (10).

In the example of FIG. 1, one or more components of system 10 (e.g., user analysis module 14) may be operable to utilize dynamic preference state model 16 to analyze actions of a particular user or users (e.g., user actions 20) and perform various operations based on the analysis. For instance, user analysis module 14 may utilize dynamic preference state model 16 to generate content recommendations (e.g., analysis results 22) for the particular user, as described below. As another example, user analysis module 14 may provide analysis results 22 that address the problem of user retention, such as a prediction of the return time of the user, as described in detail below. As yet another example, user analysis module 14 may generate, recommend, or enact any number of business decisions, such as strategic decisions (e.g., what type of content or what content to provide), policy decisions (e.g., what type of content to allow or restrict), layout decisions (e.g., how to organize content for consumption on a website or in a streaming service), or others. That is, the techniques described herein may assist in content organization decisions and/or business decisions of a content provider to better obtain and/or retain customers/consumers by applying a dynamic model of users' preference states.

By accounting for the dynamic nature of preferences in the modeling of user behavior, even with respect to continued exposure to the same or similar content, the techniques of the present disclosure may provide improved accuracy of user desires and improved prediction of user behavior. That is, the techniques described herein provide a novel approach for capturing, analyzing and/or modeling preference dynamics in temporal user behaviors and address the gaps in existing methodologies for dealing with changing user interests, which do not model the evolution of preferences with time and past experiences of the user with respect to the consumption of the same content.

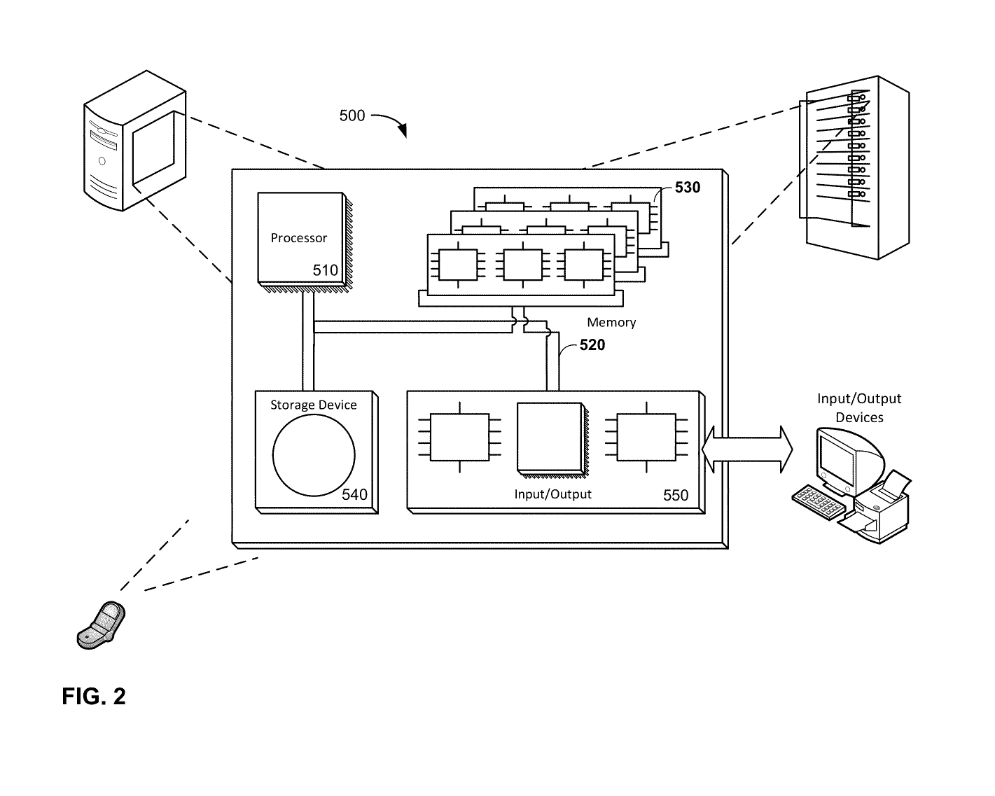

FIG. 2 is a block diagram showing a detailed example of various devices that may be configured to implement some embodiments in accordance with one or more techniques of the present disclosure. For example, device 500 may be a laptop computer, a mobile device, such as a mobile phone or smartphone, a workstation, a computing center, a cluster of servers or other example embodiments of a computing environment, centrally located or distributed, capable of executing the techniques described herein. Any or all of the devices may, for example, implement portions of the techniques described herein for modeling and/or application of dynamic user preference states.

In this example, a computer 500 includes a processor 510 that is operable to execute program instructions or software, causing the computer to perform various methods or tasks, such as performing the techniques for modeling dynamic user preference states as described herein. Processor 510 is coupled via bus 520 to a memory 530, which is used to store information such as program instructions and other data while the computer is in operation. A storage device 540, such as a hard disk drive, nonvolatile memory, or other non-transient storage device stores information such as program instructions, data files of the multidimensional data and the reduced data set, and other information. The computer also includes various input-output elements 550, including parallel or serial ports, USB, Firewire or IEEE 1394, Ethernet, and other such ports to connect the computer to external devices such a printer, video camera, surveillance equipment or the like. Other input-output elements include wireless communication interfaces such as Bluetooth, Wi-Fi, and cellular data networks.

The computer itself may be a traditional personal computer, a rack-mount or business computer or server, or any other type of computerized system. The computer, in a further example, may include fewer than all elements listed above, such as a thin client or mobile device having only some of the shown elements. In another example, the computer is distributed among multiple computer systems, such as a distributed server that has many computers working together to provide various functions.

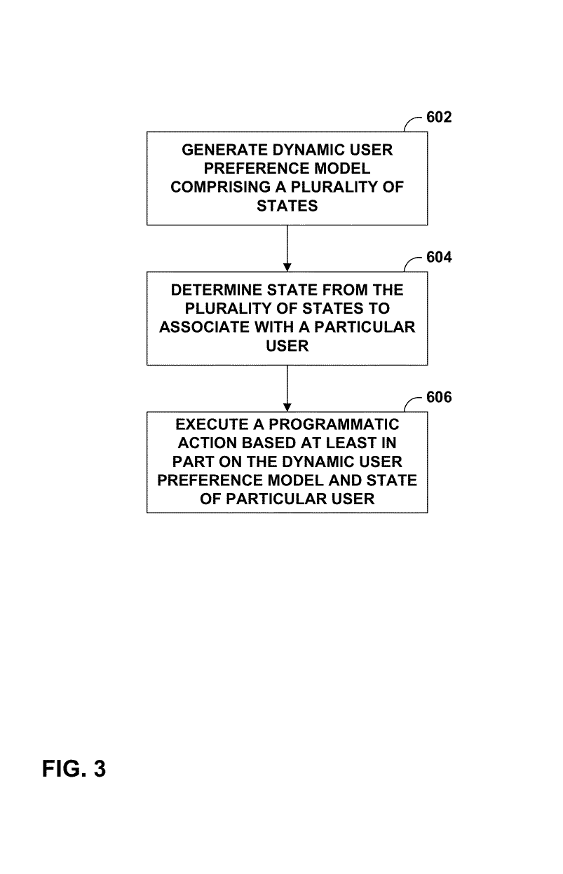

FIG. 3 is a flow diagram illustrating example operations for media recommendation using psychological preference states in accordance with one or more techniques of the present disclosure. For purposes of illustration only, the example operations of FIG. 3 are described below within the context of FIGS. 1 and 2.

In the example of FIG. 3, computer 500 (e.g., system 10) generates a dynamic user preference model (602). The user preference model may comprise a plurality of states and may account for temporal changes in content preferences of a user. In some examples, computer 500 may generate the model based at least in part on data indicating previous actions of one or more users.

Computer 500, in the example of FIG. 3, determines a state from the plurality of states to associate with the particular user (604). In some examples, computer 500 may determine the state based at least in part on data indicating content consumed by a particular user.

In the example of FIG. 3, computer 500 executes a programmatic action based at least in part on the dynamic user preference model (606). For instance, computer 500 may generate, based on the state associated with the particular user, at least one content recommendation for the particular user. As another example, computer 500 may determine, based at least in part on the state associated with the particular user, a predicted retention of the particular user and execute the programmatic action further based at least in part on the predicted retention of the particular user, such as sending an electronic invitation to the particular user or sending a notification to an adminstrator.

Models for Dynamic User Preferences and their Applications

The disclosure describes techniques for reliably predicting dynamic and changing user preferences. While the disclosure describes the framework in terms of selecting music, the described techniques may be applicable to any type of online content delivery system (e.g. movies, books, clothes, holiday destinations, and the like).

The described techniques provide a framework that incorporates history and time dependent changes in user preferences for items. Two types of changes in user preferences are identified. Firstly, user's interests are modeled as either favoring familiarity or looking for exploring new content. Secondly, user's preferences for familiar items are defined to change as a function of exposure for incorporating the psychological effects of boredom from repetition. Such a framework for estimating dynamic preferences of users provides unprecedented insights to user changing needs. These insights may help solve two important problems for content services; user retention and temporally-aware recommendations.

One application of user modeling is temporally-aware recommendations. Content consumers find themselves with more options than they can handle. The constant need for the users to make choices such as which posts, blogs or articles to read, which videos or movies to watch, what music to listen, what games to play etc. can be quite overwhelming. As a result, many businesses now incorporate recommendations as an integral part of the services offered by them. While, methods have been perfected to exploit similarity structures between users and their preferences for items for recommending them new content, these models have accrued criticism for concentrating extensively or entirely on past behavior, resulting in recommendations which tend to be ‘too similar’ and are often disliked by the users. Furthermore, such methods have largely assumed preferences to be either static or to gradually drift with time without proposing any predictive mechanisms for such dynamics. Such an approach ignores the sequential and temporal structures in user's preferences, and their future evolution. For example, consider the choices of a user for viewing a movie. It is easy to see that the movie that the user views today depends not only on the types of movies she generally likes, but also, the movie she saw recently allowing psychological factors such as boredom and the need for variety to emerge. Hence, there is strong temporal dependence in user choices with past choices not only informing preference inference but simultaneously modifying future preferences and choice dynamics.

Another application of user modeling in accordance with the techniques described herein is user retention for delivery of content over a computer network. Since most web services act as content delivery engines (e.g., StumbleUpon, Last.fm, Pandora, Spotify, YouTube etc.), their ability to provide interesting content can be one of the vital factors for keeping their users engaged. As a result, the changes in user preference and the ability (or inability) of the service in catering to the same, can have direct impacts on user retention metrics, which are yet to be explored in the retention community.

The techniques described in this disclosure provide a framework for dealing with dynamics in user preferences. Such dynamics are defined by formalizing different states of the users and their preferences for items. Furthermore, the transitions between these state are defined as a function of time and past experiences of the user. The users are assumed to alternate between two preference states, a preference for familiarity and the preference for exploration. The familiar items are further segregated based on their level of satiation into four states, namely: Sensitization, Devaluation, Recurrence and Dropped. Such dynamic preference states of the users provide insights about their changing needs, which were otherwise not available. These insights may be used to advance solutions to two major applications of user modeling described above: retention and recommendations. In order to address the retention problem, firstly, a model has been proposed for predicting the time taken by a user to return to a web service. Subsequently, the model would be refined to allow modeling the effect of particular user preference states on their return behavior. The knowledge of dynamic needs of the user is further proposed to be incorporated in the design of a new methodology for making better recommendations. An approach for clustering items based on similarities in user-item preferences and also their dynamics for recommendations, is discussed. Hence, the research agenda impacts the state-of-the-art in user modeling with application to both the areas of retention and recommendations.

FIG. 4 is a block diagram illustrating an example user dynamic state transition model. An overall framework for specifying the history and time dependent dynamics in user preferences is now described. The framework is based on formulating the notion of preference states for users and the items in their choice set. As a user exposes herself to items over time, based on her choices she naturally divides the space of items available to her (X) into two disjoint sets:
1. Familiar Items (X^{f}): Such constitute items which the user has explored in the past, and
2. New Items (Xⁿ): Such constitute all the items in the choice set other than the familiar items; Xⁿ=X−X^{f}.
   The preference states for users are also defined. At any point in time, a user can either prefer items from the set of familiar items, in which case she is said to be in the familiarity state, or the user can chose new items not explored before, in which case she is defined to be in exploratory state. Such a state representation embodies the inherent drives for familiarity and exploration from behavioral psychology discussed earlier.

However, the above state definition is insufficient for defining factors which produce transitions between user preferences states for familiarity and exploration. Specifically, the psychological effects of boredom for producing exploratory tendencies in individuals are considered in this work. Hence, items within the set of familiar items are further classified based on their satiation levels as belonging to one of the following preference states:
1. Sensitization (X^{fs}): This state constitutes of the items which are preferable because of the user's recent exposure to them.
2. Devaluation (X^{fd}): This state is defined by a decrease in interest for items which the user has already been exposed to enough times.
3. Recurrence (X^{fr}): This state comprises preferable items which were temporarily devalued due to boredom. The preferences for these items have reinstated after sufficient reduction in exposure.
4. Dropped (X^{fl}): This state comprises items whichare devalued and beyond reinstation.

A user in the familiarity state chooses items which are sensitized or are likely for recurrence. Furthermore, the user tends to avoid items in the devalued state. Depletion in the sensitization and recurrence states and expansion in the devaluation state are identified as the factors causing the user to transition to the exploratory state. Finally, the intent of the exploratory states is to produce new additions to the familiar and sensitized state. FIG. 4 shows the state transitioning structure between the various preference states for users and items outlined above.

Given, this state representation, two types of state dynamics need to be defined, namely: (a) The dynamic membership of familiar items in the Sensitization, Devaluation, Recurrence and Dropped off states with exposure and (b) A dynamic user familiarity-exploration state transition model given the preference states for the familiar items of the user.

Dynamics in Preference States for Familiar Items with Exposure.

A hazard based approach is defined for specifying dynamic preference states for familiar content as a function of past exposure. Hazard functions may be used in survival analysis for defining the instantaneous rate of occurrence of events. In order to use such functions for modeling user's preferences dynamics with exposure, two types of event rates are specified:
(a) Rate of Exit: The rate of choosing an item again given the consecutive number of times (run length) user has chosen the item in the immediate past.
(b) Rate of Entry: The rate of choosing an item again given the time gap since the last time the item was chosen.

In the absence of any exposure specific dynamics, the exit and entry event rates would be constant for different lengths of exposure or absence of exposure, respectively. However, when these hazard functions computed using the music listening histories of users from the public dataset from the music service Last.fm, were compared against the average rate of return for the items, two distinctive phases corresponding to stickiness and boredom emerged. The stickiness phase was marked by a larger rate of choosing items which were chosen recently than average. Such periods of enhanced preference for recently exposed items are used to define the Sensitization preference state for the item. The items were also found to exist in the boredom phase wherein they were chosen with a lower rate than average after they have already been exposed to enough times in the past. The period that an item existed in the boredom phase was used to define the Devaluation preference state. The preference for items was found to reinstate with enough time spent away from the item. The items are then said to belong to the Recurrence preference state. Finally, items which are not chosen for extremely long periods of time are classified as belonging to the Dropped preference state.

### A Familiarity-Exploratory State Transition Model.

A state transition model for preferences of a user for familiarity and exploration is now proposed. The model is developed by analyzing the music listening choices of the users from the Last.fm dataset. Two types of user actions are defined: the search action when a user listens to song after actively searching for it and the radio action when a user chooses to listen to a song appearing in a radio stream. The song listened by the user can be further classified as familiar or new based on whether they belong to the familiar items or new items. Finally, the following four states are defined:
(a) Search Familiar: the familiarity state corresponding to a user listening to a familiar song after searching for it,
(b) Radio Familiar: the familiarity state corresponding to a user listening to radio comprising of familiar songs,
(c) Search New: the exploratory state corresponding to a user listening to a new song after searching for it, and
(d) Radio New: the exploratory state corresponding to a user listening to radio comprising of new songs.

A predictive model of user state dynamics between the above four states is defined using a semi-markov model. A semi-markov model is particularly applicable for this problem as it allows defining state dependent dynamics for particular states using state-specific hazard functions.

### Applications: User Retention.

The disclosure describes an approach for predicting the return time of a user for addressing the retention problem for web services. Specifically, a Cox's proportional hazard model is used for modeling the return time data for the users. This model further allows incorporating several user-specific covariates that affect the rate of user return. The model includes covariates related to the typical visitation patterns of the user, their satisfaction/engagement with the service and for abstracting the effects of external factors. A few covariates capture each of the above aspects in the model. The proposed model was tested using datasets from two music services and showed better performance than other state-of the-art data mining methods. Furthermore, the model could further improve its prediction performance using the length of absence already observed for the user. This was due to the ability of the hazard based approach to incorporate the decline in the user return rate with time spent away from the service.

In some examples, the model may incorporate covariates related to the psychological preference states for items and users described earlier, which may allow a model to analyze for the first time, how user preference dynamics impact their engagement and satisfaction with the service and in turn affect their return behavior to the domain.

### Applications: Recommendation Methods.

Past efforts in recommendations have largely explored similarity structures in user choices to predict their preferences for items. Some of the popular probabilistic models which learn latent similarity structures in user preference patterns to recommend them new content include variable mixture models such as probabilistic latent semantic analysis (pLSA), Latent Dirchlet Allocation etc.

These generative models are based on the principle of exchangeability, i.e. they produce the same features or clusters for different permutations of the data. However, as discussed earlier, user preference data has strong temporal dynamics resulting in dependencies between data observations from the same user. The disclosure proposes to adapt these distance-dependent formulations to simultaneously cluster users, items and their temporal dynamics resulting from exposure.

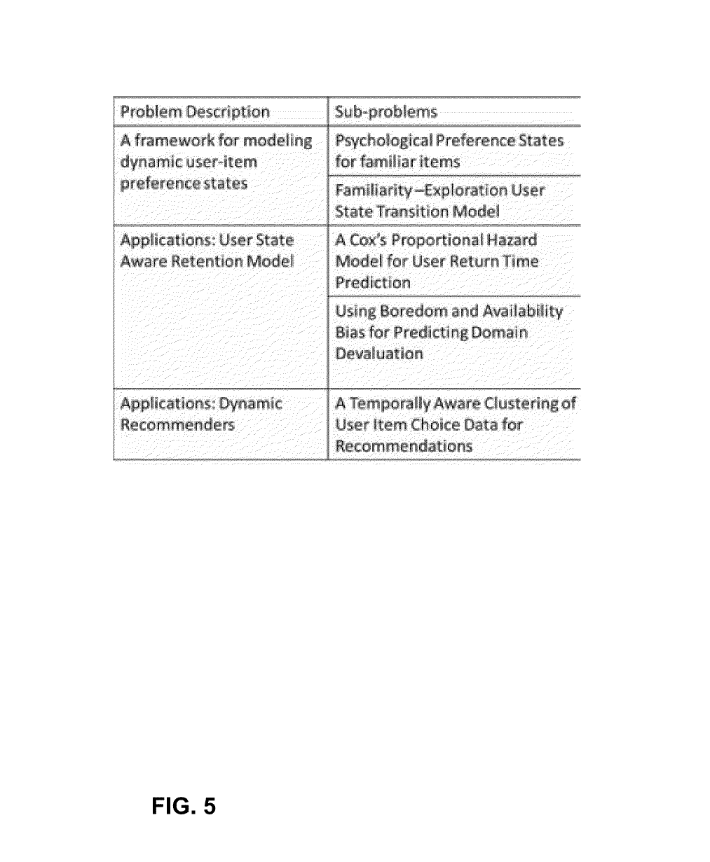

FIG. 5 is a table describing problems in modeling user preferences addressed by the techniques described herein.

The above disclosure describes a framework for modeling satiation effects in user preferences for familiar content arising due to boredom. The model also incorporates changing preferences of users for familiarity and exploration. Such dynamics are related to devaluation in preferences for the familiar content. Finally, techniques described apply the dynamic framework for user history and time dependent preferences for providing solutions for the problems of retention and recommendations. Such an approach seeks to utilize advancements in behavioral psychology for defining predictive models of dynamic user preferences.

### Measuring Spontaneous Devaluations in User Preferences

Systems and methods are described for tracking spontaneous devaluation in user preferences to predict of the onset of boredom in users cater to their changed needs. Recommendation systems have become a popular means of suggesting relevant content to the user. As discussed above, conventional methods in recommendations have focused on constructing estimates of user preferences based on their history of choices. These preference estimates are then used to suggest new content to the user using content-based or collaborative methods. Content-based methods use a user's preference estimates to find similar content, while collaborative methods use a user's preference estimates to identify similar users (neighborhood) and recommend content popular in the identified neighborhood. But, it is not sufficient for a recommender agent to only estimate a user's past preferences; it's also important to predict their future preferences given past experiences. This makes the task of a recommender even more challenging by requiring it to predict when and how a user's preferences will change in the future. Conventional content recommendation systems, however, lacks models which can predict changing preferences of users, even with respect to the same currently being consumed or content similar thereto, and doing so can be challenging.

Individuals often develop disinterest and even dislike for their highly preferred content both temporarily and lastingly. It is common to find that one's clothes, food, entertainment, jobs, etc. have grown boring despite being enjoyable in the past. This phenomenon is called a spontaneous devaluation of one's preferences or boredom fora stimulus. Spontaneous devaluation is seen to arise when repeated exposure to a stimulus creates a feeling of satiation towards it leading to a loss in interest. Alternatively, spontaneous devaluation has been linked to lost opportunity for novel experiences when similar experiences are repeated too often. Both theories concur in suggesting that, in contrast to recency-based expectations, repeated exposure to familiar choices spontaneously devalues one's preference for them.

Human behavior driven by these dynamics could be modeled as systematically alternating between one's set of choices, assuming that the time spent in experiencing other stimuli is sufficient to mitigate the effects of boredom for a particular stimulus. Several studies on user purchase behavior have found buyers to alternate among their preferred alternatives. However, in practice users have a non-uniform liking for different alternatives in their choice space. Furthermore, users have a pronounced tendency to stick to their recent choices which has been responsible for the success of the previously proposed recommender models. This behavior is called the ‘sticky’ behavior in users. This phenomenon has also been called reinforcement or inertial behavior. Such behavior can be explained to arise due to an actual increase in liking on exposure or a tendency to avoid switching costs.

The presence of both stickiness and devaluation effects in user preferences make predicting the temporal choices of a user non-trivial. The disclosure analyzes user music listening behavior to extract signals of stickiness and boredom. The analysis is limited to the music domain due to availability of public datasets, nevertheless, the results may be applicable to other items like movies, videos, books, vacation packages, shopping etc. which are fairly susceptible to boredom effects. The disclosure demonstrates the use of hazard functions for measuring these phenomena and may inform design of future methods that incorporate these dynamics, producing agents that can cater to new needs of users suffering from boredom.

The disclosure describes an analysis based on complete temporal music listening histories of users provided by Last.fm. Last.fm is a popular music website with millions of active users. It allows users to purchase tracks, listen to online radios and playlists etc. and has additional social networking features as well. Recently, Last.fm made available a dataset of complete music listening histories of around 1000 users as recorded till May 2009. This is the only known publicly available dataset to provide complete temporal records of user choices. Because Last.fm hosts several online radios, it is quite probable that parts of the user histories capture radios, and playlists rather than active user choices. The effects were filtered by using the time gap between two consecutive tracks played by the user. Last.fm has a generous list of API's available to developers. The API, track.getInfo, was used to retrieve the duration of most of the songs in the dataset. The time gap between song 1 and song 2 was compared in that temporal order in the user history with the length of song 1. If the time gap was found to be more than the length of song 1 by less than 5 seconds, song 2 was identified to belong to an automated play list. All tracks ‘not on autoplay’ were assumed to be active user choices. The auto-play effects for the songs whose lengths were unavailable through the API could not be removed. This corresponded to 0.05% of the songs. The analysis considered only the first 1 year of each user history. All the users which had less than 30 records of activity were eliminated from the dataset. Also, the only artists that were kept in the user history were artists that the user had listened to 15 or more times in that period of 1 year. Some statistics about the dataset are summarized in Table 1.

TABLE 1
Staistics from the Last.fm dataset

| Property | Value |
|---|---|
| # unique tracks | 1,084,872 |
| # unique artists | 174,091 |
| # Users | 957 |
| Mean history length- | 6716 |
| # songs heard | |
| Mean history length- | 177 |
| # active days | |
| Mean # unique artists | 37 |
| heard | |

### TERMINOLOGY

Based on both the novelty-seeking and stimulus satiation theories of devaluation of preferences, repeated exposure to a stimulus causes devaluation in one's preferences towards it. Additionally, devalued preferences can get reinstated after a period of reduced or no exposure. A music piece can stimulate the listeners because of the combined effect of its multiple features (artist, genre, tempo, strong female vocals, etc.). For simplicity and ease of access, the artist of the songs is used as the basic stimulus. More sophisticated stimulus definitions that model the interaction between multiple features of a song can enhance the disclosed method.

Preferences have been linked to choice probabilities in the past. It is only a logical extension to relate changes in preferences to changes in choice probabilities, and in particular, conditional choice probabilities. The disclosure proposes that the phenomenon of devaluation produces two different patterns in the choice probabilities of users for an artist.
Hypothesis 1: The probability that a user will listen to an artist again will decrease after he has listened to the artist some number of times. When this happens, the user's preferences for the artist have devalued.
Hypothesis 2: Devalued preferences can get reinstated after a sufficient period of non/reduced exposure to the artist.

The disclosure describes a methodology for detecting this devaluation in user preferences and analyzing its properties. This disclosure also describes specific applications for driving specific programmatic actions within a computing environment.

The state of the user at some time t is considered to be defined by the artist of the song the user was listening to at that time. The temporal history of the user comprises the sequence of states visited by him as a function of time; i.e. H^{u}(t)=sₐ if user u was listening to artist a at time t. User u is said to enter a state a at time t if H^{u}(t)=sₐ and H^{u}(t−1)≠sₐ. A user u is said to exit a state a at time t if H^{u}(t)≠sₐ and H^{u}(t−1)=sₐ.

The following conditional choice probabilities are defined as follows:
1. Conditional probability of exit: This is the conditional probability of a user u exiting state a at time t given that he last entered state a at time t−r and has not exited state a yet. Formally, the probability is equal to (H^{u}(t)=sₐ|H^{u}(t−1)=sₐ . . . , H^{u}(t−r)=sₐ, H^{u}(t−r−1)≠sₐ). Here, r is the time spent listening to the artist and corresponds to the idea of a run length in Bawa's model. The model is simplified by making the assumption that this probability depends only on r. Hence, the conditional probability of exiting state a by user u when time spent in state is r is represented as P^{ua} (exit|time spent in state a=r).
2. Conditional probability of entry: This is the conditional probability of user u entering a state a at time t given that the user last exited state a at time t−(o+1). Formally, this corresponds to P(H^{u}(t)=sₐ|H^{u}(t−1)≠sₐ, . . . , H^{u} (t−o)≠sₐ, H^{u}(t−o−1)=sₐ). Here, o is the time spent not listening to the artist a. Again, the model is simplified by assuming that this probability depends only on o. This assumption may be relaxed, with interesting effects, as described below. Thus, this probability can also be represented as the conditional probability of entering state a after having exited it o units oftime ago or P^{ua}(entry|time spent out of state a=o).

The definition of time has been kept ambiguous in the definitions above. It is now define more formally. Time can be defined in terms of the order in which songs are heard by the user such that H^{u}(t) refers to the t-th song heard by user u. Such a definition, however, does not take the actual time gap between consecutive listenings into account. It is important to consider the actual time gap between user choices. This is because a user satiated with an artist can get unsatiated both by listening to other artists or due to forgetting if he returns to the system after a long time. To analyze the impact of actual clock time on the satiation level, time is defined in terms of days since the first historical record of the user. Accordingly, H^{u}(t) refers to the state of the user on t-th day since day 1. For simplicity, the state of the user on a day is defined by the artist listened to most frequently by him on that day.

### Methodology.

Survival Analysis is a statistical method commonly used for modeling time-to-event data. The purpose of this kind of analysis is to model the probability of survival (where the occurrence of the event corresponds to death) beyond a certain point in time. For simplicity, a discrete measures of time tεN is used. The survivor function at time t is defined as:

S(t)=P(T>t) (1)

Where, T is a random variable denoting the time of death. The instantaneous rate of occurrence of the event at time t, conditioned on having survived up to time t, is captured using the hazard function. The hazard function is also called the conditional failure rate and is defined as:

$$λ ( t ) = {lim}_{Δ t \to 0 \vert} \frac{P ( t \leq T < t + Δ t \vert T \geq t )}{Δ t} = - {S}^{′} ( t ) / S ( t ) \qquad ( 2 )$$

The hazard rate function is used to compute the exit and entry conditional probabilities defined above. By setting Δt=1, the terms hazard rate and conditional probability of death can be used interchangeably. Two different hazard curves are constructed based on the event definitions.

1. Exit Hazard Rate: Here, the time from the point when a user u entered a state a is measured. The event corresponds to his ‘exit’ from the state. The random variable Tₑₓᵢₜ^{ua} denotes the time of exit or death. This hazard rate captures the conditional probability of exiting the state at time t+1 having survived in the state for time t or greater; λₑₓᵢₜ^{ua}(t)=P^{ua}(Tₑₓᵢₜ^{ua}=t|Tₑₓᵢₜ^{ua}≧t).
2. Entry Hazard Rate: Here, the time from the point when a user u exited a state a is measured. The event corresponds to his ‘entry’ back into the state. The random variable T_{entry}^{ua} denotes the time of entry or death. This hazard rate captures the conditional probability of entering a state at time t having survived outside the state for time t or greater; λ_{entry}^{ua}(t)=P^{ua}(T_{entry}^{ua}=t|T_{entry}^{ua}≧t).

An exit and entry hazard rate can be defined for each artist a user listens to. The analysis pools across the different users and the artist choices to compute an average exit and entry hazard rate for the entire dataset. The time of entry and exit variables are normalized to mitigate the effects of differences in a user's preferences for different artists and differences across users. The time of event variable is log transformed as well as it becomes harder to exactly predict the time of an event as time for which the event has not happened increases. In other words, this means that if a user has not returned to an artist in a month, it is more difficult to predict the exact day of his return, than, when he has not returned to the artist for a day. The log transform accommodates this non-linearity in the predictability of return time.

$${T}_{i}^{N} = \frac{{log}_{2} ( {T}_{i}^{ua} )}{{log}_{2} ( \frac{1}{Pu ( a ) )}} \qquad ( 3 )$$

for a user u and artist a and iε{‘entry’,‘exit’}. P^{u}(a) is the prior probability of user u being in state a.

$${P}^{u} ( a ) = \frac{{N}^{u} ( a )}{{L}^{u}} \qquad ( 4 )$$

where, N^{u}(a) is the number of times user u was in state a and L^{u} is the length of user u's history. The average hazard rates for the normalized time of event variable can then be computed across users and artists:

λᵢ(t)=P(Tᵢ^{N}=t/Tᵢ^{N}>t) (5)

Time t is broken into discrete intervals (0, 0.1], (0.1, 0.2] and so on. The hypotheses presented above can now be represented using the hazard rates.

1. Hypothesis 1. The exit hazard rate for an artist should be an increasing function of time. This indicates that a user's preferences for an artist decrease with increased exposure to the artist.
2. Hypothesis 2. The entry hazard rate for an artist should be an increasing function of time. This indicates that user preferences for the artist are reinstated after sufficient time gap.

The sticky or inertial view of user choices, on the other hand, suggest that a user's probability of visiting a state would increase on having visited it. Contrary to the devaluation hypothesis, the conditional probability of visiting a state again would increase as time spent in the state increases. This implies that the exit hazard rate for an artist is a decreasing function of time for sticky users. The entry hazard rate, would also be a decreasing function of time as a user would be less likely to visit a state which they has not visited for long periods of time.

A common analysis methodology is to compare the hazard rate of interest in an analysis with that generated from a control experiment. This is done to remove the effects of covariates not being considered in the analysis. Four baseline models to serve as controls. Listening sequences were constructed by simulating user histories using each of the baseline models for every user. The user histories were simulated by sampling randomly from the temporal preference vector (Pref) generated by each of the model. In order to make the baseline models as close to the real data as possible, the parameters of the models were fitted to the actual user histories. The four baseline models are as follows:

1. Random (R): The user is assumed to sample states randomly from his average preference vector (P^{u}). Pref^{u}(t)=P^{u}
2. 1st order Markov (M1): A user's switching probability from one state to the other is assumed to be controlled by a 1st order Markov model. The dynamics of the Markov model are controlled by a static transition matrix (T^{u}) which is learnt for each user u's history using maximum likelihood estimation. Pref^{u}(t)=Pref^{u}(t−1)*T^{u}
3. Time weighted (TW): The recency based model for generating user histories is shown as Pref^{u}(t)=a^{u}*Pref^{u}(t−1)+c^{u}(t−1), where, c^{u}(t−1) is 1*|A| choice vector, which is set to 1 at index i if H^{u}(t−1)=sᵢ, and is 0 otherwise. The parameter α^{u} is a|A|*1 vector which was fit to the user u's history using stochastic gradient descent. A small exploratory component is introduced to this model to prevent extremely long lengths of continuous listening of the same artist. Therefore, the modified preference vector is computed as Pref′^{u}(t)=0.95*Pref^{u}(t)+0.05*P^{u}
4. Linearly increasing or decreasing (L): The temporal model of user preference is shown as. Pref^{u}(t)=P^{u}+sign(t−L^{u}/2)*(t−L/2)^{β}^{^{u}}. The parameter β^{u} is a|A|*1 vector and was fitted to the user u's history using stochastic gradient descent.

The Log-Rank test can be used to test whether the survival distributions generated by the simulated models are sufficiently different from that of the real data. The hypothesis test is defined as:

Hₒ: The real data and the simulated data have different survivor function
Hₐ: The real data and the simulated data have the same survivor function

The Log-Rank test on the real and the simulated survival functions rejects the null hypothesis with a p-value <10-6. The discrepancy between the real data and the baseline model predictions can be quantified using a A hazard rate obtained by subtracting the simulated hazard rates from the hazard rates computed on real data.

$${λ}^{Δ} ( t ) = - \frac{{S}^{′ real} ( t )}{{S}^{real} ( t )} -- \frac{{S}^{′ ( simulated )} ( t )}{{S}^{( simulated )} ( t )} \qquad ( 6 )$$

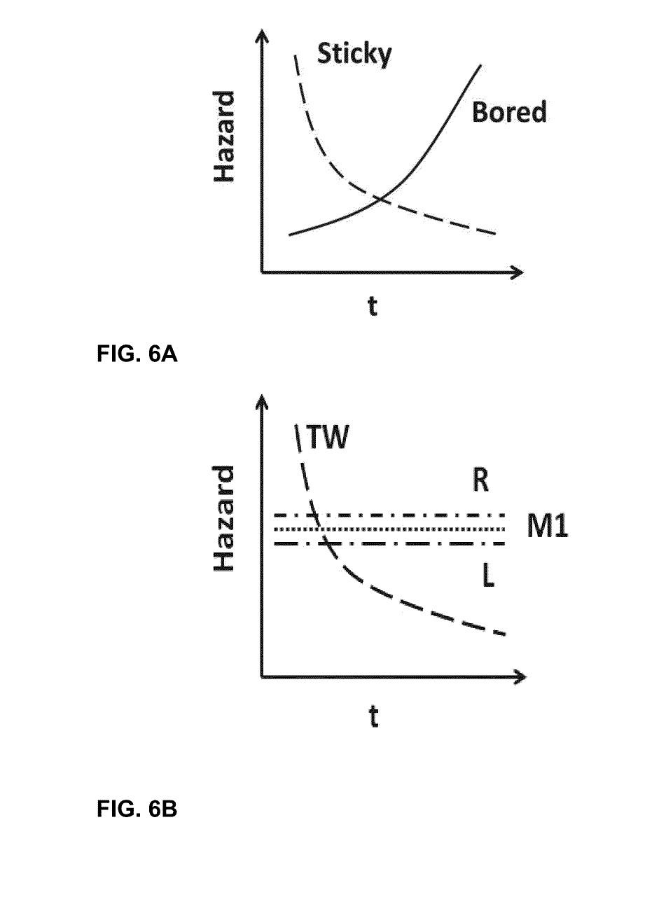

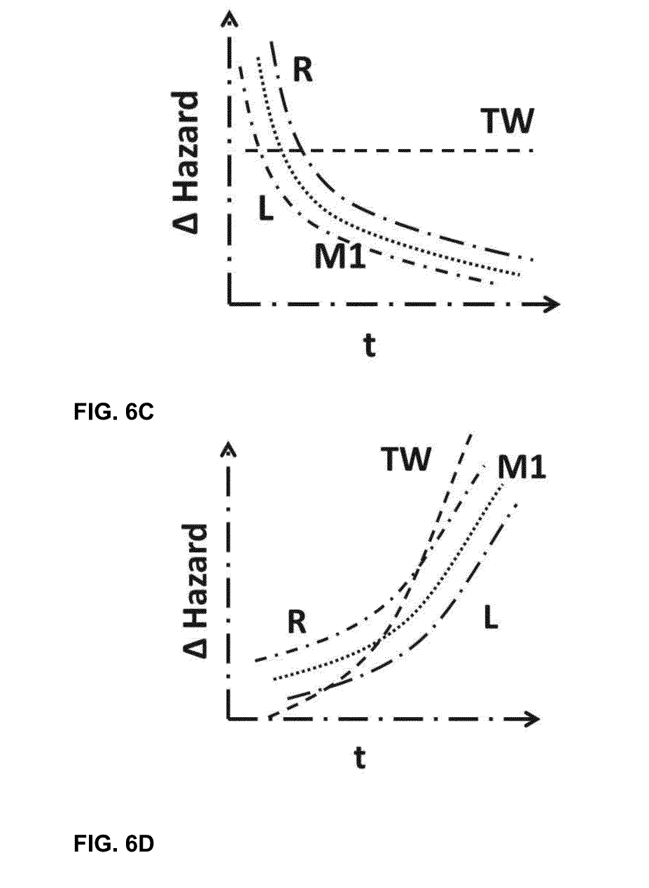

FIGS. 6A-6D are graphs illustrating example hazard rates for content users.

Based on the four models, four A hazard rates are generated for both the entry and exit time events for the analysis, namely real vs. random (λᵢ^{A-R}), real vs. Markov (λᵢ^{A-M1}) real vs. time weighted (λᵢ^{A-TW}) and real vs. linear (λᵢ^{A-L}), where iε{‘entry’,‘exit’}.

FIGS. 6A-6D display the entry and exit hazard rates expected for the event times obtained from the ‘sticky’ and ‘boredom prone’ models and those expected from the baseline models in FIG. 1. The entry and the exit hazard rates for a random, markovian and linear model should be independent of time spent in the state. A TW model on the other hand, is essentially a sticky model. Hence, the exit and entry hazard rates for TW model would decrease with time. The objective of this study is to understand the form of the exit and entry hazard rates for the real data. FIGS. 6A-6D displays the expected A hazard rates if the real data follows the sticky and the boredom-prone model, respectively.

### Results.

This section examines the obtained A exit and A entry hazard rates in closer detail.

### Δ Exit Hazard Rates.

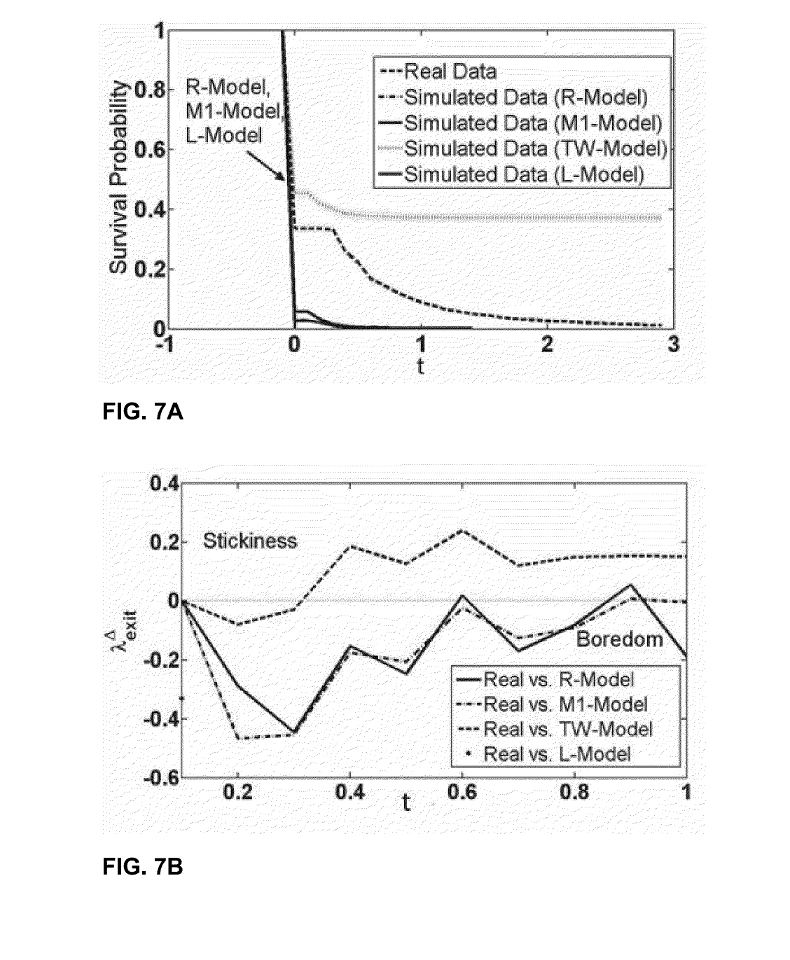

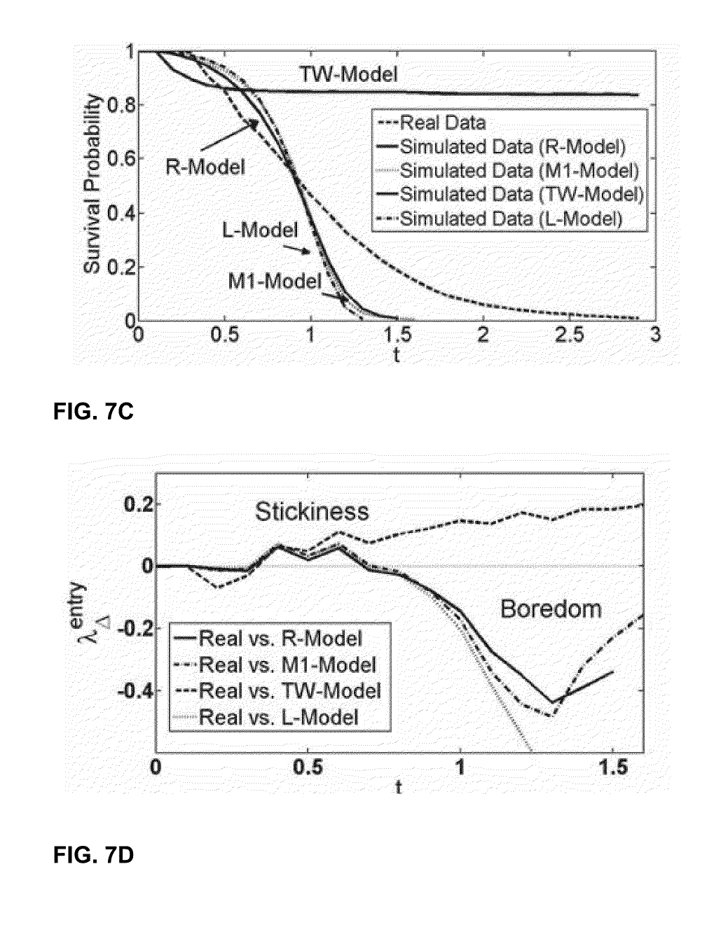

FIGS. 7A-7B are graphs illustrating example survivor functions for a content user's exit time. FIGS. 7A-7B display the survivor functions for the exit time for the real data and data generated by each simulated model. FIGS. 7A-7B also depicts the obtained Δ exit hazard rates. The changes in λₑₓᵢₜ^{A-R}, λₑₓᵢₜ^{A-M1} and λₑₓᵢₜ^{A-L}, directly represent changes in the λₑₓᵢₜ for the real data. Changes in λₑₓᵢₜ^{A-TW} would depict changes in the exit hazard rate for real data against a decreasing baseline.

1. Real Vs. Random, Markov and Linear models: The λₑₓᵢₜ^{A-R} and λₑₓᵢₜ^{A-M1} are negative throughout suggesting that the exit rate for the real data is lower than that expected for the baseline models. This supports the sticky view of user preferences suggesting that a user has a lower rate of exiting a state after having visited it. However, contrary to what is expected for the sticky model, the Δ exit hazard rate increases with time after a point. One might expect the Δ hazard rate to eventually flatten out, becoming uninformative. The survival function for R, M1 and L models drops sharply indicating a lower probability for large sequences than those observed in the real data. The L model has the sharpest drop in survival probability, and did not provide enough samples of exit times greater than 0.1.
2. Real vs. Time-Weighted model: λₑₓᵢₜ^{A-TW} is negative for low values of t, suggesting larger stickiness in users than generated by the TW model. However, the Δ exit rate increases thereafter, becoming positive after some time. Since, the exit hazard rate for the TW model is expected to decrease with time, this suggests that the exit hazard rate for real data increases more than the decrease observed in the TW model.

From these observations one can conclude that users have high stickiness towards the state on entering the state. However, the stickiness for a state reduces with time and the dynamics driven by boredom start dominating as time spent in the state increases. A user is thus likely to stick to his previous state at a higher rate initially and a decreased rate as time in the state increases.

### Δ Entry Hazard Rates.

FIGS. 7C-7D are graphs illustrating example survivor functions for a content user's entry time. FIGS. 7C-7D display the survivor functions computed for the entry time variable for real and simulated data and the obtained Δ entry hazard rates. Similar to the A exit hazard rates, the changes in λ_{entry}^{A-R}, λ_{entry}^{A-M1} and λ_{entry}^{A-L} functions would depict changes in the entry hazard rate for the actual data. The TW model is expected to have a declining entry hazard rate, being a sticky model. The changes in λ_{entry}^{A-TW} should reflect changes in the entry hazard rate for the real data against a decreasing baseline.

1. Real Vs. Random, Markov and Linear models: The λ_{entry}^{A-R}, λ_{entry}^{A-M1} and λ_{entry}^{A-L} functions are positive initially suggesting that the users have a higher rate of entry than that expected from the baseline models. This again can be attributed to the sticky nature of user choices, such that users have a high rate of returning to the artists they had listened to recently. The A hazard rates decrease for intermediate values oft suggesting a prominent devaluation in preferences. The Δ hazard rates eventually increase for larger values of t. However, they do not cross the 0-line again suggesting that a user always has a lower rate of return than that generated by the baseline models. This can be attributed to phasing out of an artist who is not being actively sampled.
2. Real vs. Time-Weighted model: The λ_{entry}^{A-TW} function is slightly negative at the beginning suggesting that the actual entry hazard rate is lower than that of a TW model. The TW model is seen to pull back users which have just left an artist at a higher rate than observed in real data. The hazard rate increases thereafter indicating the actual data seems to have a larger rate of return than that of the TW model.

The analysis on the Δ entry hazard rates reveals aspects of sticky behavior in users which produces quick switches in and out of the artist. The analysis also reveals indicators of devalued preference for intermediate values of time spent out of the state. Preferences are reinstated after longer periods of time spent away from the artist, however, the rate of return eventually flattens out becoming uninformative.

### Previous Return Time.

Users may quickly switch in and out of an artist in a short span of time. Such a characteristic of user temporal choices suggest that a user's level of exposure to an artist is not completely defined by the ‘in time’. A user who has just switched out of the artist and has switched back in almost immediately after, somewhat continues to be in state a. Therefore, the previous return time (PRT) T_{entry}^{N,P} may also indicates how much a user has been exposed to the artist recently. A low PRT indicates higher exposure to the artist than a larger PRT. A corollary to hypothesis 1 in terms of the T_{entry}^{N,P} for the artist follows:

Corollary 1′—The probability that a user listens to an artist again will depend on his PRT to the artist. If the user has returned to the artist quite quickly previously, he may have a lower rate of returning quickly to the artist in the future.

The hypothesis is tested by generating two conditional entry hazard rates.

1. λ_{entry}^{LP} Hazard Rate given a low PRT, T_{entry}^{N,P}<1
2. λ_{entry}^{HP} Entry Hazard Rate given a high PRT, 1<T_{entry}^{N,P}<1.5

The Δ hazard rate for the two conditional entry hazard rates is calculated as follows.

λ_{entry}^{LP-HP}=λ_{entry}^{LP}−λ_{entry}^{HP} (7)

λ_{entry}^{LP-HP} function is computed for the real data and data simulated using a Markov model. The simulated data serves as a comparison.

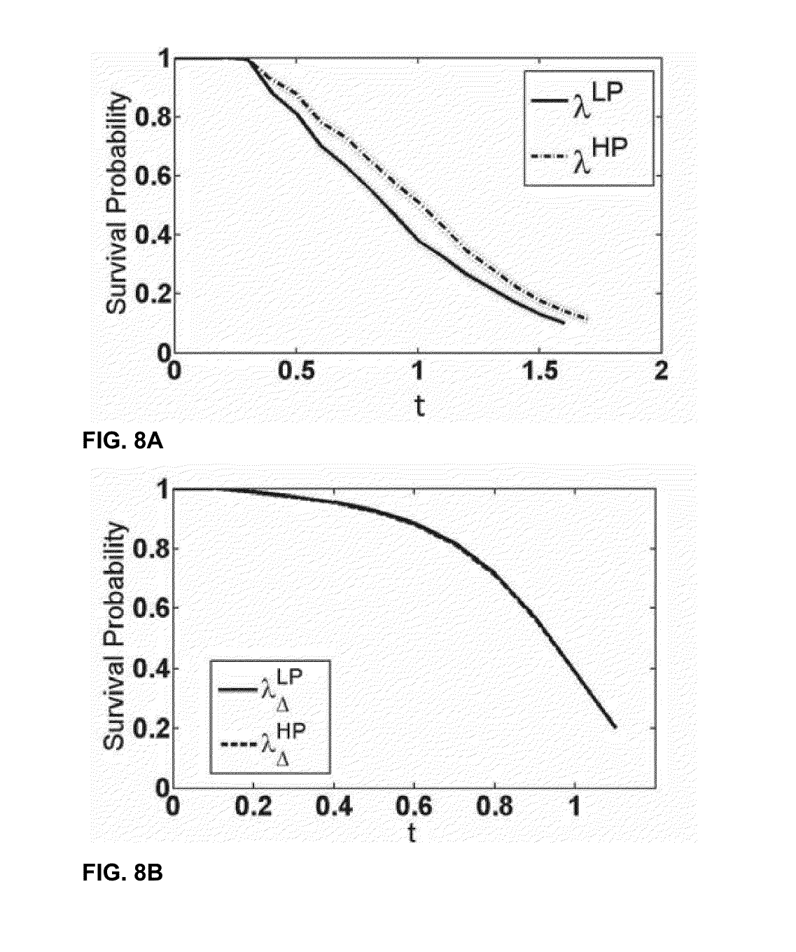

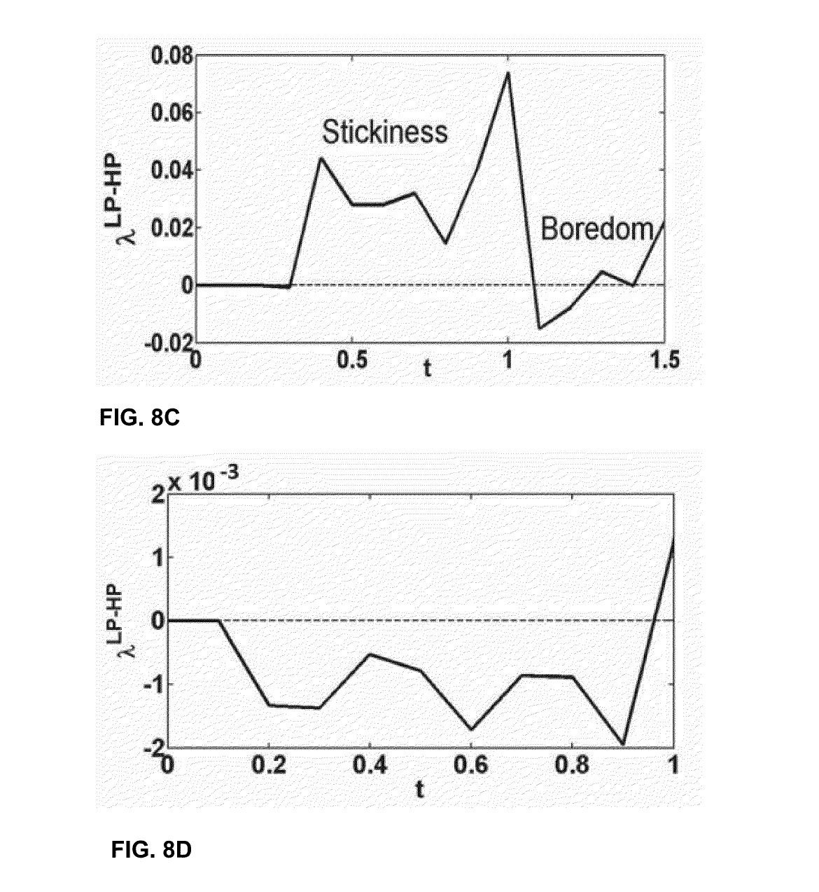

FIGS. 8A-8D are graphs illustrating example survivor and exit hazard functions. FIGS. 8A-8D display the obtained λ_{entry}^{LP-HP} functions and the survival functions for λ_{entry}^{LP} and λ_{entry}^{LP} for the real data and simulated data. The log rank test is rejected with a p-value of less than 10-4 on the conditional survival functions of the simulated and the real data. However λ_{entry}^{LP-HP} varies by very small amounts. On the contrary, λ_{entry}^{LP-HP} on the real data varies in an interesting way. λ_{entry}^{LP-HP} is highly positive initially, which indicates increased stickiness when PRT is low. However, λ_{entry}^{LP-HP} decreases and becomes negative eventually which indicates a lower rate of return for larger values of t when PRT is low than when PRT is high. Hence, once a user is out of the state he has a lower rate of returning back to the state when previous return time is low than rate of return for a user-artist pair for whom previous return time was high.

The techniques described in this disclosure outline a methodology for analyzing music listening histories of Last.fm users for studying the phenomenon of spontaneous devaluation in user preferences or boredom. The disclosure describes hypotheses about boredom prone behavior in Last.fm users. Exploratory analysis of dynamic hazard rates computed on both the real and simulated data suggest that real data has strong evidence of spontaneous devaluation of preferences, as hypothesized. The analysis results suggest stickiness or reinforcement nature of past choices in users. Crucially, stickiness and boredom effects on user choices were found to be spaced out in time suggesting that methods can be designed to systematically appease the two driving forces effecting user temporal needs. The results obtained from this analysis motivate the design of sophisticated dynamic models of user choices impacting recommendation methods, product design and advertising.

The analysis results suggest that methods which only focus on maximizing similarity, or focus on maximizing both similarity and diversity at all times, accommodate only some aspects of user behavior, leaving useful temporal information on the table. Sophisticated temporal models of individual preferences, well grounded in cognitive and psychological analysis of the dynamics of their choices, are required for the design of automated methods that can predict user temporal needs well.

### A New Approach for Diversity in Recommendations Using Psychological Preference States for Items.

The disclosure describes methods and techniques for recommending content to content consumers. Recommendation models use past user choices to infer their preferences, which form the basis for making future recommendations. Changing preferences is significant challenge for these methods, requiring continuous preference tracking to allow for temporal changes in preferences such as shifts in user interests using time weighting and drift functions. However, none of these approaches model the process of evolution of preferences with time and as a result of the past user choices. The techniques described herein compute models that account for spontaneous devaluation or boredom due to repeated exposure to stimuli of the same or similar content item. Existing models have no mechanism for tracking such effects of exposure to similar items on future preferences. Example web services that may implement the techniques include computer-implemented services that deliver content from content repositories storing, such as entertainment websites providing recommendations for music, movies, blogs, books, and the like.

The disclosure describes methods of modeling preferences to display certain types of time and history dependent dynamics, particularly the dynamics of satiation for familiar content by proposing for the first time a dynamic item preference state model. The described model identifies different latent preference states for content items currently being consumed by the user. These states are called the Sensitization, the Boredom and the Recurrence states. Dynamics in a user's preferences for items are attributed to the dynamics in these item states. The disclosure provides empirical validation for the described model by analyzing music listening data from Last.fm. Further, the model, together with a specification for its dynamics constitutes a comprehensive framework that provides unprecedented capabilities for modeling the temporal needs of the users. Pragmatically, the disclosure describes methods to generate better state-dependent recommendations for the users, which is shown through a pilot study. The disclosure also discusses the utility of the described model for designing exploratory recommenders.

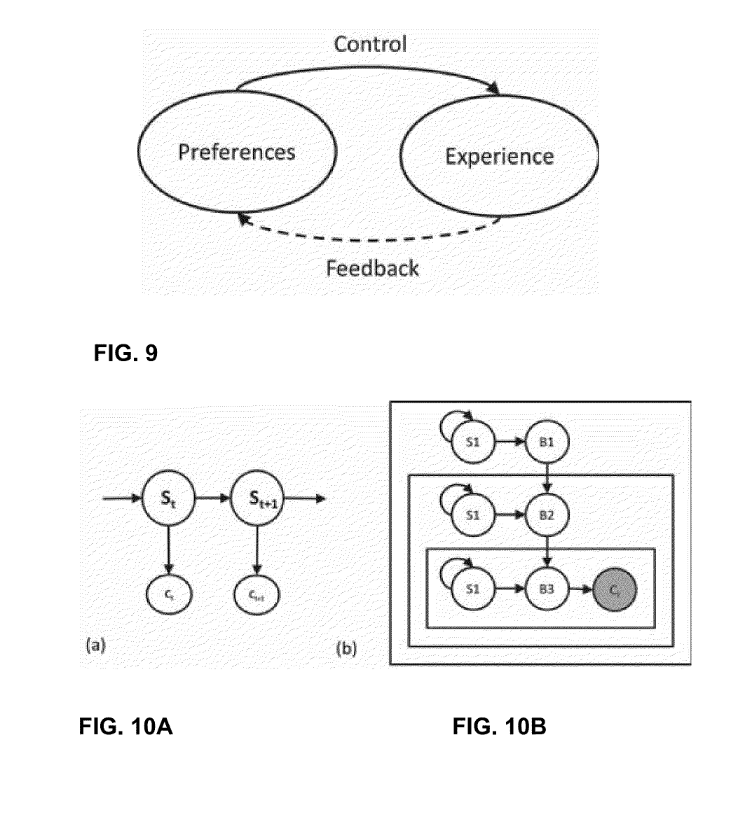

Decision theory has classically assumed preferences to be static in nature allowing us to quantify them using a single numerical measure, called the utility. Utilities capture the propensity to choose each item in a user's choice set, and can specify the probability of the user choosing an item a −Pₐ^{u}, through formulas like:

$${P}_{a}^{u} = \frac{U ( a )}{{Σ}_{o ∈ O} U ( o )} \qquad ( 1 A )$$

where, O is the set of items in user u's choice set and U(o) is the utility associated with item oεO. However, static utilities fail to explain many kinds of human behaviors observed in practice. A specific example, and the topic of discussion for this paper, includes the effect of exposure on user preferences for consuming media commodities like music, videos and text. Users consume media on a daily basis today. However, with the current scale of media repositories, the content a user consumes is often a drop in the ocean of what is available. It is only logical to suggest that a user's preferences directly define their niche in the market and justifies the practice of inferring preferences from one's choices of content. However, what is overlooked as a result, is the effect of user experiences on their future preferences which is directly responsible for the dynamics of the consumption process (FIG. 9).

FIG. 9 is a block diagram illustrating an example of the dynamic interaction between user preferences and user choice of content.

Psychological studies have shown that preferences are dynamic, and are affected by the frequency of exposure to a commodity. Moderate exposure is needed to acquire preferences. However, existing preferences spontaneously devalue after repetitive exposure and is associated with the psychological state of boredom or stimulus satiation. At the same time, less frequent repetition can reinstate one's preferences for a commodity, also identified as the mere-exposure effect and is referred to as reinforcing, inertial or sticky behavior. The inherent drive for exploration also constitutes an important element of human behavior which leads individuals towards desiring new and novel content. Such a preference is hypothesized to result from curiosity for new information or is linked to stimulus satiation responses to familiarity.

Dynamics in preferences have only recently come under the purview of the computer science community, due to the increasing need for designing automated agents that can assist humans in their day to day decision making. Choosing the next movie to watch, the next song to listen, the next article to read, etc. are ubiquitous daily choices. Recommender systems attempt to simplify the process of searching for suitable content by providing high quality suggestions. The recommendation community has been instrumental in advancing research in representations, models and methods for extracting and applying knowledge of user preferences from activity logs. While, methods have been perfected to exploit similarity structures between users and their preferences for items for recommending them new content, these models have accrued criticism for concentrating extensively or entirely on past behavior, resulting in recommendations which tend to be ‘too similar’ and are often disliked by the users. Furthermore, researches have shown that this problem is further exacerbated when recommendations need to be produced over and over again. As a result, a major initiative in the recommendation community is to move beyond similarity to produce diverse and novel recommendations. Furthermore, temporal models have been proposed to accommodate changes in user preferences. However, a major deficit of these methods have been the lack of a framework for modeling and predicting the psychology of user preference dynamics given past experiences.

The disclosure describes techniques to advance existing computational methodologies for examining and modeling real world temporal preference data by proposing a model for the dynamics of satiation for familiar content. The techniques allows one to incorporate the feedback from user experiences on their future preferences resulting in a more inclusive specification of the dynamic process of content consumption than had before. The techniques are based on an analysis of the temporal patterns in a user's consumption of items, where an item is the unit of resource such as a song, a video or an article. Items are seldom consumed in isolation. For example, users generally have multiple playlists of songs each of which fulfills the need for a different genre and style of music, such as pop, rock or country. Similarly, users watch videos and movies from different categories like comedy, drama or suspense. Such categories may again comprise multiple sub-categories forming a natural hierarchy of items with each increasing level of the hierarchy representing smaller and more specialized sets of items. The sets of items in each level of the hierarchy are called separate consumption bundles. The disclosure describes techniques for studying the dynamics in user preferences for such bundles of items. The item bundles exist in multiple preference states. For example, a user may be increasingly addicted to a certain set of songs, genre of movies or topics, but having completely saturated those categories, may later seek something completely new and different. In order to capture these dynamics, the disclosure proposes a novel dynamic state model for a user's preference for items bundles. Further, modeling the dynamics in the preference states for item bundles at different levels of the hierarchy allows us to generate the observed dynamics in the item consumption behaviors.

The disclosure provides empirical validation for the state model by analyzing the music listening patterns of users using a public dataset from the popular music service, Last.fm. Three preference states for items and their bundles are identified as follows: user stickiness for recent content (Sensitization), their boredom with saturated content (Boredom) and the return of preference after forgetting (Recurrence). Users are found to display distinct consumption behaviors in these states which are captured using a mixture model. Such a model of user psychological states for items and the state dependent dynamics provides new directions for designing temporal recommenders. For example, the explicit state definition provides a richer context to user needs which can be exploited to generate temporally relevant content rankings. This allows construction of sophisticated recommendations models which can identify, for example, when to stop recommending content based on similarity when such content is no longer preferable and when to start recommending it again. Further, the model for satiation has important implications to the design of exploratory recommenders under the premise that such needs arise out of boredom with familiarity.

### A Dynamic Item Preference State Model.

The disclosure describes a novel dynamic preference state model for item consumption. The disclosure describes the following hypothesis for item consumption behavior:

State Hypothesis: Items exist in multiple distinct preference states.

State Dependent Consumption Hypothesis: A user's temporal rate of consumption of an item is dependent on its preference state.

Dynamic State Hypothesis: The preference state for an item changes with time.

The state hypothesis and the state dependent consumption hypothesis jointly postulate that items exist in multiple latent preference states which produce different state-dependent dynamics in the temporal rate of consumption of items. The last hypothesis suggest that items change their preference states over time, thereby altering their temporal consumption behaviors.

FIG. 10A is a block diagram illustrating an example of the Dynamic State Hypothesis model. FIG. 1 OA represents the item consumption rate observation variable (Ct), as dependent on the item state (St). The model is extended to consider dependencies between items captured using a hierarchy of item bundles discussed earlier.

FIG. 10B is a block diagram illustrating an example of the Bayesian model. FIG. 10B shows the Bayesian model for a 3-level hierarchical organization of items. For ease of description, the model is considered to correspond to a simple hierarchical organization of music into different genres which are composed of a number of artists and their songs. The outermost plate would then represent the different genre variables and the innermost plate would represent the individual song variables. Each item bundle variable, at each level of the hierarchy, is associated with a preference state variable. The innermost song variable generates the observed consumption rate variable for the song.

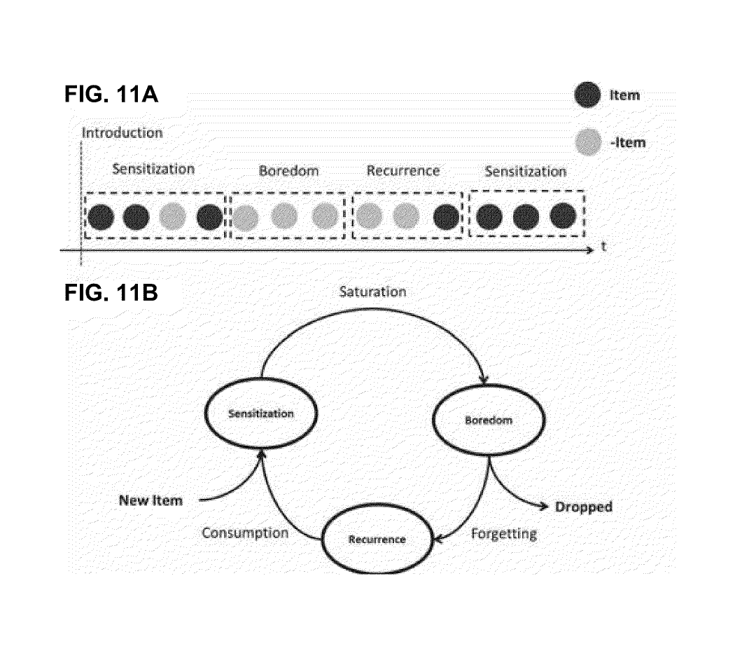

FIG. 11A is a conceptual diagram illustrating an example dynamic item preference state model. The disclosure describes three distinct preference states for items and describes the dynamics between these states. The states can be described as:

1. Sensitization: The process of sensitization is identified in the learning literature as a reinforced response to a repeated stimuli. Here, this state is used to define the tendency of a user to return to an item at an increased rate soon after exposure due to an enhanced preference for recently exposed items. Possible explanations for this behavior include an actual increase in liking for the stimuli on exposure and/or a tendency to avoid switching costs.
2. Boredom: Spontaneous devaluation in preferences is observed to result from repeated exposure to stimuli causing satiation or boredom due to loss of interest. Studies have modeled boredom as an increasing function of the number of times the stimuli is repeated. An item is said to exist in the boredom state when the user's preferences for the item have devalued as a result of exposure.
3. Recurrence: Studies in stimulus satiation or boredom have found preferences for devalued stimuli to return with time due to forgetting. The recurrence state identifies devalued items which have become viable for consumption after reinstation of their preferences.

FIG. 11B is a conceptual diagram illustrating the dynamics between the preference states. The preference state model specifies the life cycle for an item after it is introduced to the user for the first time. The item first enters the sensitization state and remains there until it is devalued and moved to the boredom state. From there, the item may get dropped permanently or instead, be elevated to the recurrence state when its preferences return. An item in the recurrence state is soon consumed by the user transferring it back to the sensitization state and the cycle resumes.

Based on the state definitions, an item may be consumed when it is either in the sensitization or the recurrence state and is unpreferable for consumption in the boredom state. Hence, sensitization and recurrence are positive preference states for items and boredom is a negative preference state. The ability to specify both positive and negative preference states for items is an attractive property of the model.

### A Model for Item (Content) Consumption Behavior

The disclosure analyzes real-world temporal preference data for empirically validating the dynamic item preference state model. The disclosure describes an approach for studying changes in user preferences as follows:

Find a setting in which users have a free choice to consume a range of items. Identify items or groups of items that constitute consumption bundles which the users would want to repeat at will. Once such bundles are identified, study how a user's rate of consuming these items changes with time. Music listening behavior renders itself quite well for such an analysis because in this setting, repetition is quite natural even at the song level. For other types of content (e.g. movies, books, clothes, holiday destinations), repetition is more natural at a higher level of abstraction, constituting states in similarity spaces defined using attributes of the items (genre, trend, categories etc.). For ease of analysis, and availability of data, the disclosure describes preference dynamics in music listeners. However, the described techniques may be applicable to other content delivery systems.

### Data and Terminology

The discourse describes an analysis based on the complete music listening histories of around 1000 Last.fm users recorded until May, 2009, recently made available by Last.fm. The dataset contains the song name, the artist name and the timestamp for the different songs the user listened to during this period. This is the only known publically available dataset that provides the complete listing of users choices during a period of time. A subset of this data is used for the analysis.

User preferences for both individual songs and for bundles comprising songs from the same artist are studied. In either case, the unit (e.g., song, artist) used for the study is referred to as an item. A user is said to have consumed an item at time t if she listened to a song attributed to the item at that time. The unit of time for the analysis is sessions, where a session is defined as a continuous stream of listening activity interrupted by only small pauses. 6 hours is defined as the threshold on the gap between two songs for terminating the session. The value of the threshold was chosen by visually examining the gap distribution and was consciously chosen to be a large number to accommodate most of the listening activity of a day in one session. Some users had exceptionally large session lengths (>500 tracks) which seemed unusual, and such users were removed from the analysis.

The disclosure describes methods of analyzing the time gap between a user's successive consumptions of an item. For example, if the user consumes an item at time t and then again at time t+Δt, the described method may analyze the distribution of the time gap, Δt between these consumption events. Henceforth, the observations of ΔT for different user-item pairs are called the gap observations.

### The Hazard Function.

Survival analysis is a branch of statistics used for modeling time to event data. Not only are these class of methods a good choice for modeling duration data, they are particularly applicable for the analysis as they can model dynamics in event rates with time. Let T be the random variable (r.v.) denoting the time at which an event occurs. Standard distribution functions such as the probability distribution, f and the cumulative probability distribution F can be defined for the r.v. T. However, survival analysis allows us to define certain special functions which capture the temporal properties of the event. Given that the occurrence of the event corresponds to death, one can define the probability of survival using the survival function defined as:

S(t)=P(T>t)=1−F(t) (2A)

The hazard function, which can be derived using the survival function, further allows one to analyze the dynamics in the event rate with time. The hazard function measures the instantaneous rate of occurrence of the event at time t, conditioned on having survived up to time t:

$$λ ( t ) = {lim}_{Δ t \to 0 \vert} \frac{P ( t \geq T < t + Δ t / T \geq t )}{Δ t} = \frac{{S}^{′} ( t )}{S ( t )} \qquad ( 3 A )$$

It can also be computed directly from the density function and the distribution function:

$$λ ( t ) = \frac{f ( t )}{1 - F ( t )} \qquad ( 4 A )$$

Extending the above terminology to the problem scenario, every time a user consumes an item it is said to correspond to the occurrence of the event. The clock is reset immediately after the event in order to track the time for the next consumption event. The hazard function then captures the rate at which a user chooses an item given the elapsed time since its last consumption. This conditional rate is used as a measure of the dynamic preference of the user for the item over time after an exposure.

### The Shape of the Hazard Function for Item Consumption Events

The shape of the hazard function for an event carries a lot of information about its dynamics. The null case is a flat hazard function which represents that the event has no dynamics. For example, if user preferences were static, one would expect the user's consumption rates for items to remain constant with time. Deviations from the flat hazard function signal interesting dynamics in the event. For example, an increasing hazard function suggests that the rate of occurrence of the event increases with time. Such hazard rates are observed for events like adoption of new products. Alternatively, a declining hazard rate is characteristic of events like responses to surveys, promotions etc. where the rate of occurrence of the event declines as time elapses.

The hazard function for gap observations for all the user-item pairs in the data are put together. These gap observations are collectively referred to using the variable T, and the hazard functions on both T and log(T) is computed. The distribution of log(T) is particularly important as the log-transform of the time variable allows accommodating for the non-linearity in the predictability of time in the future, i.e. the difficulty in predicting T increases with T. For example, it is much easier to predict a difference between T=1 and T=2 then to predict a difference between T=30 and T=31. The gaps are computed, measured in sessions, at the song level for the first three months of user activity.

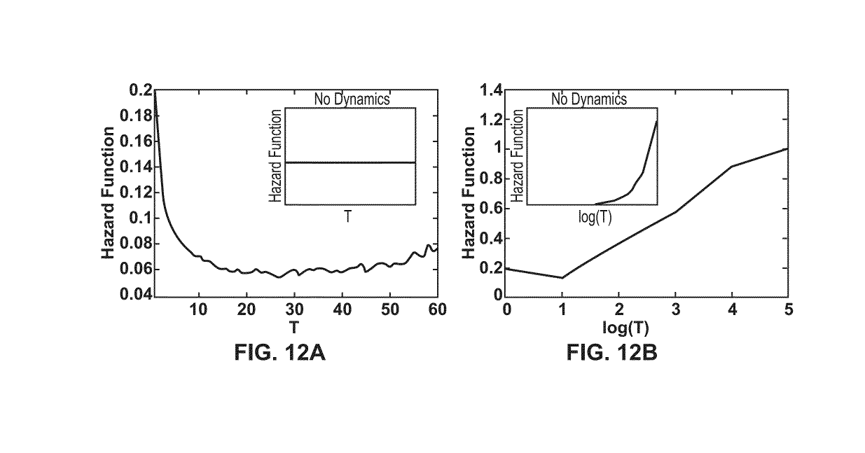

FIGS. 12A-12B are graphs illustrating an example hazard function. FIGS. 12A-12B display the computed hazard functions for T (FIG. 12A) and log(T) (FIG. 12B) variables. A small inset displays how these hazard functions would look if the event rate was independent of time (i.e. the event had no temporal dynamics). Some important observations made from these plots include:

1. The hazard function computed on T has a declining shape which suggests that users consume items at a decreasing rate with time since the last consumption.
2. The hazard function computed on log(T) has a bimodal shape. Its declines initially, and increases thereafter with a declining rate of increase.
3. Both these hazard functions differ considerably in shape from the null hazard rates displayed in the inset.

Thus, the analysis focuses on the distribution of the log transform of the gap variable.

### Dependence on Frequency

Further analysis of the log gap variable is done by assuming a parametric form for its distribution. The log-logistic distribution was used for this purpose as it allows the shape of the hazard function to be non-monotonic, as seen for the latter part of the plot (FIG. 8B). The log-logistic (LL) distribution is a two parameter distribution which has hazard function defined as:

$$h ( x ) = \frac{( \frac{β}{α} ) * {( \frac{x}{a} )}^{β - 1}}{1 + {( \frac{x}{a} )}^{β}} \qquad ( 5 A )$$

The hazard function has a non-monotonic shape when β>1, while the hazard function decreases monotonically for β≦1. The bi-modal shape of the hazard function can be captured using two LL distributions. The first component is defined with β=1 to capture the initial declining shape of the hazard. Values off β less than 1 are not considered as the hazard function diverges at 0 for those values. The second component of the mixture is used to generate a non-monotonic shape of the hazard and has β>1.

log(T)˜p*LL(αₛ,1)+(1−p)*LL(αᵣ,βᵣ(>1)) (6A)

Our previous analysis provided important insights about item consumption behavior of users but had averaged out the differences between the various user-item pairs. Data scarcity, however, prevents the computation of individual distributions per user-item pair. Instead, the dynamics in the rate of consumption for items may bear similarities for similar frequencies of consumption. The frequency for a user-item pair is defined as the average rate at which the user consumes the item, computed as follows:

$$( 7 A )$$

$${f}^{ui} = \frac{No of sessions in which the user u consumed the item i}{Total number of sessions for the user u}$$

The disclosure describes a simple strategy of clustering user-item pairs based on their frequencies. The pairs are first sorted based on their frequencies and then divided into 300 (an arbitrary number) equal sized clusters. Each cluster is represented by the average frequencies of the user-item pairs it contained. The simple strategy gives reasonable clusters for the exploratory analysis.

The analysis uses a maximum likelihood estimation for fitting a mixture of LLs on log(T_{c}^{f}) for the different clusters, where T_{c}^{f} denotes the gap observations for a cluster with frequency f. In one example, the analysis is performed at the song level. The mle function from the Statistics Toolbox in MATLAB is used for estimating the model. The function internally uses the fminsearch function in MATLAB that finds the local minima of a function given an initial estimate using unconstrained nonlinear optimization. The initial estimate was arbitrarily fixed and did not significantly affect the output.

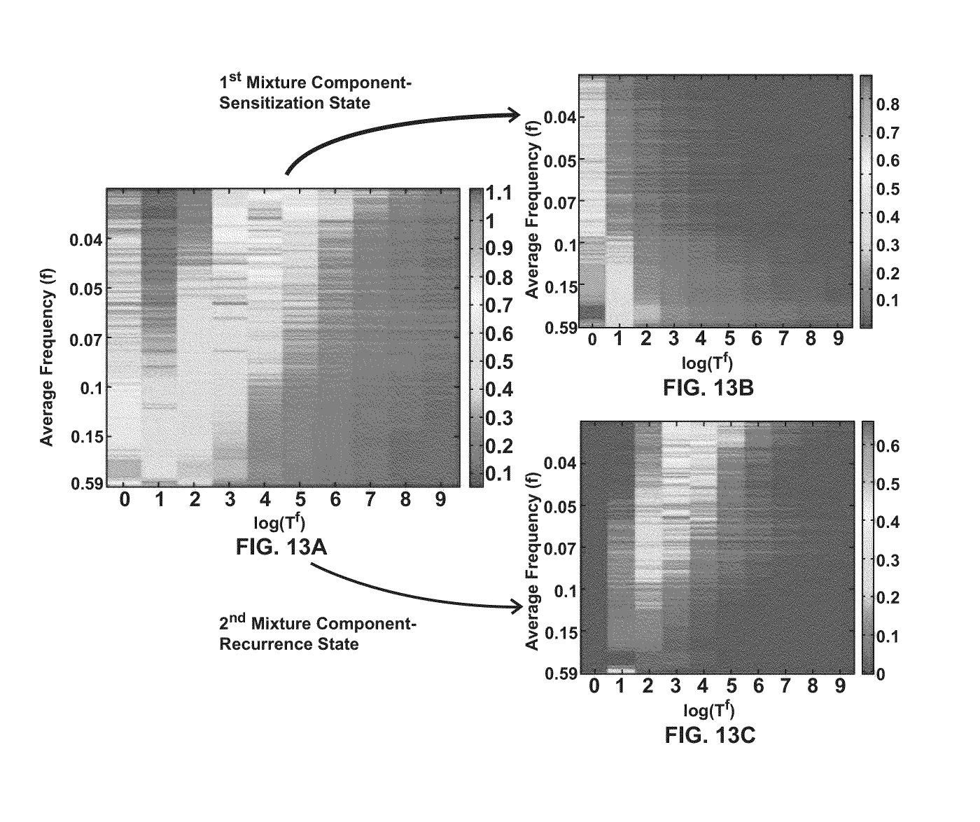

FIGS. 13A-13C are conceptual diagrams illustrating example hazard functions. FIGS. 13A-13C show the estimated hazard functions for different frequency clusters laid alongside each other and sorted based on the average frequencies for each cluster.

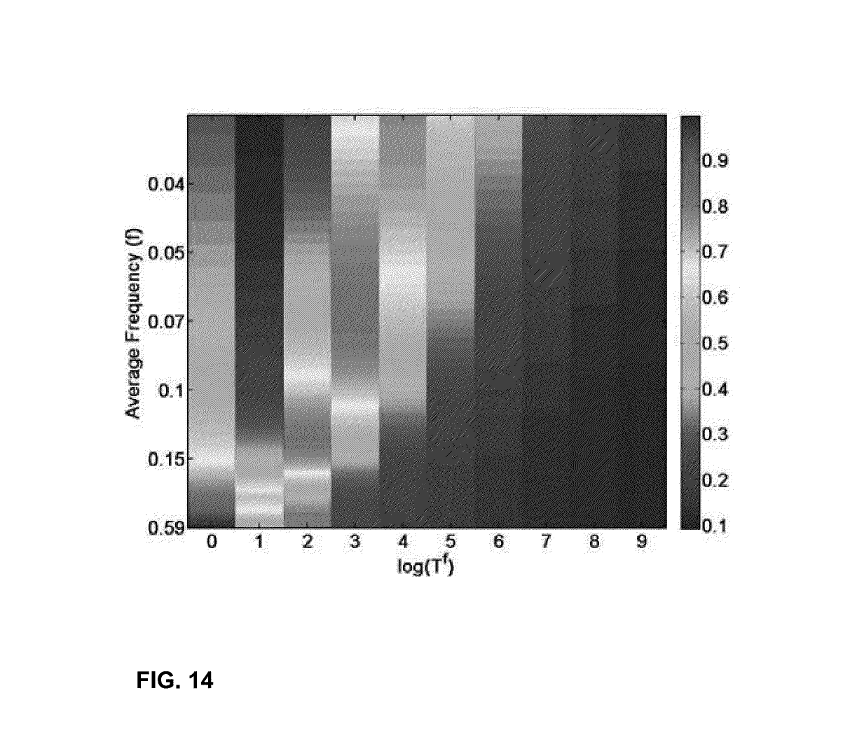

FIG. 14 is a conceptual diagram illustrating an example hazard function. FIG. 14 reveals important properties of the shape of the hazard function for different frequency clusters summarized below:

1. The hazard functions corresponding to different frequency clusters contain two distinct components. These components include the sensitization and the recurrence components (FIG. 13A).
2. The spread of the sensitization component increases with frequency (FIG. 13B).
3. The time corresponding to the peak and the spread of the recurrence component decreases with frequency. Items which have higher frequency return earlier and their returns are more predictable than items which have lower frequencies (F IG. 13C).

### A Preference-Based Mixture Model for the Temporal Rate of Item Consumption.

The disclosure proposes a complete mixture model for the dynamic consumption rates for items given their frequency of consumption. The model is specified such that given the frequency of consumption (preference), f, for a user-item pair, the distribution for the gap r.v. T^{f} is defined using the following equations:

p^{f}˜Logistic(p₀+p₁*f)

αₛ^{f}=exp(s₀+s₁*f)

αᵣ^{f}=exp(r₀₀+r₀₁*f)

βᵣ^{f}=1+exp(r₁₀+r₁₁*f)

log(T^{f})˜p^{f}*LL(αₛ^{f},1)+(1−p^{f})*LL(αᵣ^{f},βᵣ^{f}) (8A)

Since frequency is itself a standard measure of static preference for items, the described model is called a preference-based mixture model for item consumption events. The mle function can be used to fit the mixture model to the temporal data. For visualization, FIGS. 13A-13B overlay the crude estimates of the cluster level hazard functions obtained at the song level with those derived for the corresponding frequencies from the learnt model, in FIG. 14. The plot suggests that the model does a good job of capturing the unique patterns in the consumption rates for different user-item pairs while smoothening out the irregularities.

Based on the dynamics generated by the two components in the mixture model, the dynamics correspond to the sensitization and the recurrence preference states for items. The state dependent consumption rates (Cᵢ(t)) for an item i for a user u with the elapsed time for a state sᵢ, given its frequency of consumption f, are defined as follows:

$$\begin{matrix}{C}_{i} ( t \vert {s}_{i} = Sensitization ) = \frac{LL ( t , {α}_{s}^{f} , 1 )}{1 - cLL ( t , {α}_{s}^{f} , 1 )} & ( 9 A ) \\ {C}_{i} ( t \vert {s}_{i} = Recurrence ) = \frac{LL ( t , {α}_{r}^{f} , {β}_{r}^{f} )}{1 - cLL ( t , {α}_{r}^{f} , {β}_{r}^{f} )} & ( 10 A )\end{matrix}$$

### Model Validation.

TABLE 2
AIC Scores results for model selection

| | | Song Level | | Artist Level | |
|---|---|---|---|---|---|
| | | | AIC/sample | | AIC/sample |
| | | AIC Scores | Scores | AIC Scores | Scores |
| Static Model | Constant Hazard on T^{f} | 3.7284e+006 | 5.4057 | 2.0702e+006 | 4.5878 |
| Declining | Declining Hazard Model on T^{f} | 3.6180e+006 | 5.3330 | 1.9962e+006 | 4.4367 |
| Hazard Models | Constant Hazard on log(T^{f}) | 3.6354e+006 | 5.3585 | 1.9893e+006 | 4.4213 |
| | Declining Hazard on log(T^{f}) | 3.8136e+006 | 5.6213 | 2.1105e+006 | 4.6907 |
| Bi-Modal | Mixture Model on T^{f} | 3.6180e+006 | 5.3330 | 1.9448e+006 | 4.3224 |
| Hazard Models | Mixture Model on log(T^{f}) | 3.4708e+006 | 5.1159 | 1.9393e+006 | 4.3102 |

TABLE 3
AIC Scores results for partitions of the gap observations into
the two components from preference-based mixture model

| | | AIC-state/sample Scores | | | |
|---|---|---|---|---|---|
| | | Sensitization | | Recurrence | |
| | | Song | Artist | Song | Artist |
| | | Level | Level | Level | Level |
| Static Model | Constant Hazard on T^{f} | 4.7346 | 3.5783 | 6.0240 | 5.9505 |
| Declining | Declining Hazard Model on T^{f} | 3.7372 | 2.7889 | 6.4406 | 6.5999 |
| Hazard Models | Constant Hazard on log(T^{f}) | 3.0373 | 2.4688 | 6.9696 | 6.9847 |
| | Declining Hazard on log(T^{f}) | 2.9600 | 2.4609 | 7.4685 | 7.6180 |
| Bi-Modal | Mixture Model T^{f} | 3.7331 | 2.8547 | 6.4434 | 6.5057 |
| Hazard Models | Mixture Model on log(T^{f}) | 3.5054 | 2.6378 | 6.2338 | 6.2493 |

TABLE 4
Performance metrics for temporal recommenders
constructed using different preference models

| | Song Level | | Artist Level | |
|---|---|---|---|---|
| | | Temporal | | Temporal |
| | Quality | Diversity | Quality | Diversity |
| Random Model | 49.91 | 0.9358 | 49.42 | 0.8448 |
| Static Model | 60.04 | 0.0824 | 66.92 | 0.0375 |
| Recency Based Model | 65.11 | 0.3503 | 69.94 | 0.2563 |
| Mixture Model for | 64.82 | 0.5476 | 69.87 | 0.3492 |
| Dynamic Preferences | | | | |
| State Conditioned Dynamic | 68.44 | 0.5574 | 73.18 | 0.3897 |
| Preference Model | | | | |

Just by visual examination, one can conclude that a mixture model is needed for fitting the bi-modal dynamics in the data. However, the necessity of a mixture model can be verified using formal model selection procedures, such as the Akaike Information Criterion (AIC) for model selection. AIC computes an overall score for a model fit by trading off the goodness of fit, measured using the maximized value of the likelihood function, and the number of free parameters used in the model. This metric is designed such that when multiple models exist, a model with the lowest value of AIC is preferred. The AIC score can be computed as:

AIC=2*k−2*log(L) (11A)

The AIC score per sample is computed as:

$$\frac{AIC}{sample} = \frac{2 * k - 2 * log ( L )}{\# samples} \qquad ( 12 A )$$

For comparison, several models are considered. The first model considered is the simplest model, which assumes no dynamics in the item consumption rate over time. This static model is realized by fitting an single parameter exponential distribution which has a constant hazard function, to the gap data: T^{f}˜Exponential(αₑ^{f}).

Several dynamic preference models are also considered, all of which assume a declining shape for the hazard function. A declining hazard rate is used to emulate the recency-based dynamics in preferences assumed in the construction of the time-weighted temporal models of recommendation. A single parametric distribution is used to estimate these models. Three different versions of the declining hazard preference models are considered:

1. Declining Hazard on T^{f}: For this model, a single LL distribution is used with the parameter β set to 1 to generate the decreasing hazard function; T^{f}˜LL(α_{d}^{f},1).
2. Constant Hazard on log(T^{f}): For this model, it is assumed that that the hazard function declines at a rate such that it is constant on the log space of time. The exponential distribution on the log transform of the time variable is used to realize this model; log(T_{f}))˜Exponential(αₑ^{f} log).
3. Declining Hazard on log(T^{f}): For this model, it is assumed that that the hazard function has a declining shape on the log space of time. The LL distribution is used with the parameter β set to 1, estimated on the log transform of the time variable to realize this model; log(T^{f}))˜LL(α_{d log}^{f}, 1).

The parameters (αₑ^{f}, α_{d}^{f}, α_{e log}^{f} and α_{d log}^{f} for a user-item pair are estimated as functions of its frequency f similar to the ones used for the mixture model, to maintain consistency among the models. Furthermore, for completeness we also consider a version of the proposed mixture model defined on the T^{f} variable rather than the log(T^{f}) variable.

In order to evaluate the proposed mixture model, the model fits on the gap observations from the first three months of user activity are compared at the song and the artist level. There were 678,422 data instances at the song level and 449,937 at the artist level. Table 2 summarizes the results.

The results show that the mixture model has the lowest AIC scores at both the song and the artist level, which indicates that even after accounting for model complexity, the proposed model is a better fit to the data compared to simpler models. Furthermore, the mixture model on log(T^{f}) performs better than the mixture model on T^{f}, justifying the modeling decision. The static model (Constant Hazard Model on T^{f}) has a bad fit to the data, which shows that much is lost on omitting the dynamics in the modeling assumption. Of the declining hazard models, the sticky model on T and the constant hazard model on log(T) have the second best AIC scores overall. This indicates that such recency-based dynamics are present in the data. However, the improvement in the AIC scores resulting from the mixture model (the Declining Hazard Model on T^{f} has a relative likelihood of less than 10⁻¹⁰ with respect to the mixture model on log(T^{f})), suggest that the second component in the mixture captures signals of recurrence behavior missed out by the sticky models.

We investigate this further by considering separate AIC scores for two partitions of the gap data, determined based on their memberships in the individual components of the mixture model. Each gap observation is assigned to the component in which it has a higher membership. The AIC scores/sample for both the partitions are then computed for the different preference models. The sensitization component had 41% of the samples at the song level and 62% of the samples at the artist level. The declining hazard model (the declining hazard model on log(T^{f})) and the static model (constant hazard model on T) do best at fitting the sensitized and the recurrence partitions, respectively. However, they are particularly bad at fitting the other component. The disclosure describes a proposed mixture model that allows modeling both the components reasonably well, which is responsible for its better overall performance at fitting the data.

The ability of the mixture model to explain the temporal preference data better than the simpler models has important implications to validating the dynamic item preference state model and its modeling assumptions. Firstly, the mixture model extracted two distinct sub-populations of item consumption events such that the consumption dynamics in these sub-populations differed considerably as seen in FIGS. 13A-13C and as defined by the Equations 9 and 10. These findings provide ground for the State Hypothesis and State Dependent Consumption Hypothesis for item consumption behavior. Furthermore, the co-existence of both the states of sensitization and recurrence for a user-item pair suggests that the state of the item changes with time. This deduction further validates the Dynamic State Hypothesis. Finally, because the findings are consistent at both the song and the artist level, this suggests that the modeling assumptions apply to both items and item bundles.

In addition to the two item states identified by the mixture model, the disclosure further specifies the state of boredom for an item. The state of boredom is defined to lie between the sensitization and the recurrence states in temporal order, such that an item is said to be in the boredom state when it is not in the other two states. Mathematically, the membership of an item in the boredom state is determined to occur when the membership of the item in the other two states is below a threshold (Td):

P(sᵢ=Sensitization)<Td and P(sᵢ=Recurrence)<Td→sᵢ=Boredom (13A)

In some examples, the mixture model includes the boredom state associated with a nil consumption rate for an item as a third component of the mixture model and learn it from the data.

The dynamic preference state model provides a rich representation of the psychological preference states of the users which allows the development of sophisticated recommenders which are cognizant of these preference states. Further modeling of the dynamics of these preference states allows us to predict how a user's state changes in the future. Such predictive abilities are immensely valuable for a recommender which aims to work ahead of the users for catering to their changing needs. Furthermore, the deconstruction of user preferences for items and their clusters into both positive and negative preference states provides additional context for identifying temporally relevant content for the user. Applications of the model for advancing designs for temporal and exploratory recommenders are discussed below.

### Temporal Recommenders

In some examples, the formulation described above is incomplete as it lacks a predictive model for the future preference states of the items. However, in some examples, another model called the State Conditioned Dynamic Preference Model, includes a novel temporal recommender based on the predictions of user future preference states. This model allow one to act ahead of the user and proactively demote content that is getting saturated and promote content that is catching on again with the user. The disclosure describes a method of evaluating such an ideal temporal recommender for recommending familiar items for the next session of the users. This model works with the correct predictions for the state of an item in the next session assuming that a hypothetical model generating these predictions is somehow available.

For this experiment, the dataset is divided into three, three months chunks. The first and second time period is used for training and the third time period is used for testing. The mixture model is re-trained to use the frequencies for user-item pairs in the first time period to make predictions of their temporal consumption behaviors in the second time period. After training the model, the model is tested on the third time period while using the frequencies of user-item pairs in the second time period of the data. Since the model is restricted to familiar content; the model only considers predictions for items that had been consumed at least once in the second time period. A ranking of the familiar items is generated for every next session of the user considering all user activities till the session before, for all the user sessions in the testing period. The generated ranking is evaluated using the expected percentile rank of the items actually consumed in that session, proposed for evaluating recommenders when explicit feedback from the user is not available. The metric for a temporal setting is extended as follows:

$$\overline{rank} = \frac{{\sum }_{u , i , {t}_{u}} {r}_{ui}^{{t}_{u}} {rank}_{ui}^{{t}_{u}}}{{\sum }_{u , i , t} {r}_{ui}^{{t}_{u}}} \qquad ( 14 A )$$

where, rᵤᵢ^{t}^{ᵤ} is 1 if a user u consumed item i in the session tᵤ for the user, and rankᵤᵢ^{t}^{ᵤ}; denotes the percentile rank of item i in the ranked list of items generated for the user u for the session tᵤ. Since a lower values of the percentile rank is desirable, we report 100—rank as the metric of quality for the models. A metric of temporal diversity of recommendation lists generated for the user over time is also considered:

$$Temporal Diversity = \frac{{\sum }_{u} \frac{{\sum }_{t}^{{T}^{u}} \frac{\vert {L}_{t + 1} - {L}_{t} \vert}{10}}{{T}^{u}}}{N} \qquad ( 15 A )$$

Where Lₜ is the list of top 10 items recommended to the user in the t-th session, |Lₜ₊₁−Lₜ| is the cardinality of the set difference between two consecutive recommendation lists, Tu is the number of sessions for user u and N is the total number of users in the testing period.

The ideal recommender is compared to multiple other models using both the quality and the diversity metrics defined above. For the ideal model, only the sensitization and the recurrence states as captured by the mixture model are considered, for making state conditioned predictions. Additionally, the following models are considered: the random model which generates random permutations of the items, the static model (constant hazard model on T), the recency based model (Declining Hazard Model on T) and the mixture model without state predictions. Evaluation are performed at the song and the artist level (Table 4). The test data had around 500 users which had at least 10 familiar items from time period 2 and at least 1 session in time period 3. The data included about 60 sessions per user. Also, the users in the test set had a temporal diversity of 0.85 and 0.7 in their session to session consumptions at the song and artist level, respectively.

The disclosed results suggest that the ideal model produces significant improvements in the quality and the temporal diversity of the recommendations. Also, in its current state the mixture model does comparable to the recency based model in quality but is considerably better in the temporal diversity of its recommendations. Both these findings suggest that there is much value to adopting an exposure based model for the dynamics in preferences resulting in both relevant and diverse recommendations over time.

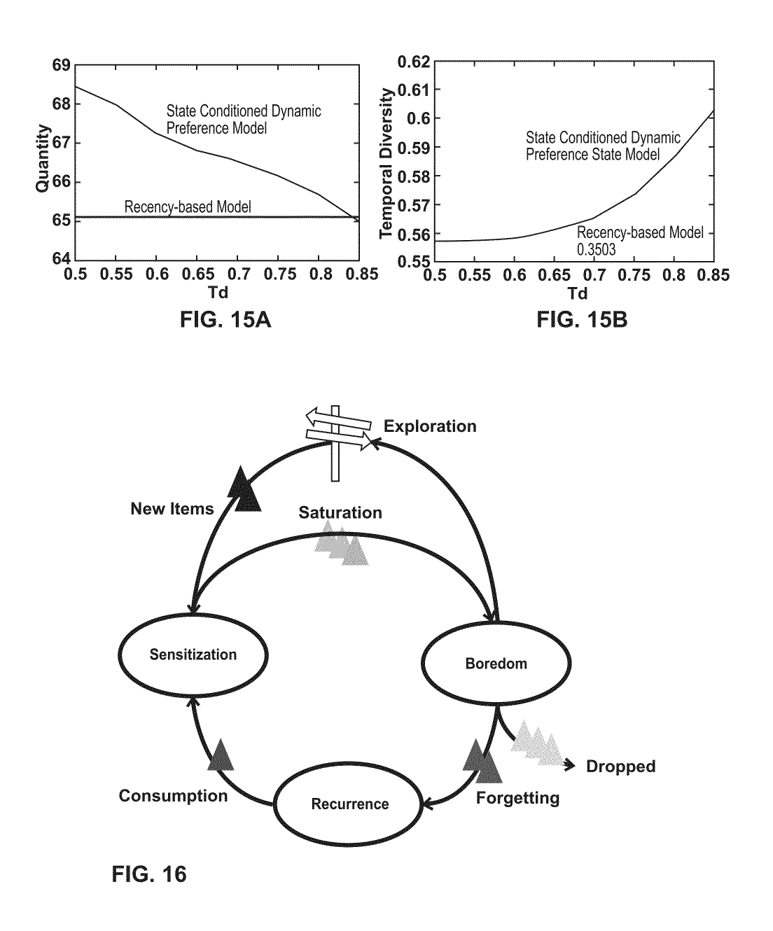

FIGS. 15A-15B are graphs illustrating an example State Conditioned Dynamic Preference Model. The boredom state is introduced, formulated using Equation 13, in the state predictions for the State Conditioned Dynamic Preference Model. The quality and the diversity metrics at the song level for the State Conditioned Dynamic Preference Model for different values of the threshold (Td) used in the formulation of the boredom state are plotted in FIGS. 15A-15B. We find that the selective elimination of saturated content provides us a principled approach for increasing the diversity of the generated recommendations.

FIG. 16 is a conceptual diagram illustrating an example dynamic item preference state model. FIG. 16 shows a dynamic model for exploration of new items based on the preference states for familiar items.

### Exploratory Recommenders

One of the psychological explanations for the urge for exploration in humans is the inevitable satiation for familiarity with repeated exposure. Under this premise, the framework for dynamics in preferences of items provides unprecedented capabilities for identifying the onset of exploratory behavior in users and addressing their needs once they are in the exploratory state. Again, we assume that we have a model for predicting the preference states for the familiar items in the future. Using this model, we can now separate user familiar items into the sensitization, recurrence and boredom states. Since, only items in the sensitization and recurrence states are preferable for consumption, depletions in these states can potentially fuel the need for exploration in the future. The idea is represented in FIG. 16, which extends FIG. 11B to shows the movement of the items between the different states. Movement of items to the boredom state is shown to prompt users to find new items that they can add to the sensitized set of items.

The disclosure describes techniques for identifying distinctive preference states for the items, such that each state generates a unique type of temporal consumption behavior. The disclosure describes a dynamic preference state model for items which captures the dynamics of satiation for familiar content. The described techniques include a recommender constructed based on the preference state model that can improve both the quality and the diversity of recommendations for its users. Furthermore, the rich context provided by the model about the future preference state of the user can guide the design of the next generation of exploratory recommenders.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims. Further details are described in the Appendices attached hereto, each of which is hereby incorporated herein by reference.

What is claimed is:

1. A computing system comprising:
a repository storing a plurality of content items;
a web service having a content delivery engine to retrieve and communicate the content items to users over a computer network,
wherein the web service maintains a dynamic user preference model comprising a plurality of states, wherein the dynamic user preference model accounts for temporal changes in content preferences of the users with respect to content items consumed by the users, and
wherein, for each user, the web service models the dynamic preferences of the user according to the states of the model, generates, based on a current state associated with the user, a recommendation of at least one of the content items and outputs the recommendation to the user via the computer network.

2. The computing system of claim 1, wherein, for each user, the web service updates the model based on a respective frequency of consumption for the content items consumed by the respective user and the time elapsed to compute a result indicative of a rate of declining preference for consumption for the content items.

3. The computing system of claim 2,
wherein the web service maintains the model to include sensitization and the recurrence preference states for the content items for each of the users, and
wherein the model represents state dependent consumption rates (Cᵢ(t)) for an item i for a user u with the elapsed time for a state sᵢ, given its frequency of consumption f as:
$${C}_{i} ( t \vert {s}_{i} = Sensitization ) = \frac{LL ( t , {α}_{s}^{f} , 1 )}{1 - cLL ( t , {α}_{s}^{f} , 1 )} , and$$
$${C}_{i} ( t \vert {s}_{i} = Recurrence ) = \frac{LL ( t , {α}_{r}^{f} , {β}_{r}^{f} )}{1 - cLL ( t , {α}_{r}^{f} , {β}_{r}^{f} )} .$$

4. The computing system of claim 1, wherein, for each user and based on the current state associated with the user, the web service organizes content items on a web pages provided to the particular user.

5. The computing system of claim 1, wherein, for each user and based on the current state associated with the user, the web service computes a predicted return time for the user that represents a computed estimate of a time in the future that the user is likely to return to the web service to request a content item that is the same or similar to a content item recently delivered to the user.

6. A method comprising:
generating, by a computing device and based at least in part on data indicating previous actions of one or more users, a dynamic user preference model comprising a plurality of states, wherein the dynamic user preference model accounts for temporal changes in content preferences of a user; and
executing, based at least in part on the dynamic user preference model, a programmatic action.

7. The method of claim 6, wherein executing the programmatic action comprises:
determining, based at least in part on data indicating content consumed by a particular user, a state from the plurality of states to associate with the particular user; and
generating, based on the state associated with the particular user, at least one content recommendation for the particular user.

8. The method of claim 6, wherein executing the programmatic action comprises:
determining, based at least in part on data indicating content consumed by a particular user, a state from the plurality of states to associate with the particular user; and
organizing, based on the state associated with the particular user, content items provided to the particular user for consumption.

9. The method of claim 6, further comprising:
determining, based at least in part on data indicating content consumed by a particular user, a state from the plurality of states to associate with the particular user; and
determining, based at least in part on the state associated with the particular user, a predicted retention of the particular user,
wherein executing the programmatic action is further based at least in part on the predicted retention of the particular user.

10. The method of claim 9, wherein executing the programmatic action comprises generating at least one of: a strategic decision, a policy decision, or a site layout decision.

11. The method of claim 9,
wherein determining a predicted retention of the particular user comprise computing a predicted return time for the user that represents a computed estimate of a time in the future that the user is likely to return to the web service and request a content item that is the same or similar to a content item recently delivered to the user.

12. A non-transitory computer-readable storage medium encoded with instructions that, when executed, cause at least one processor to:
maintain, by a computing system and for each of a user that has previously consumed content items from a content repository from the computing system, a dynamic user preference model comprising a plurality of states, wherein the plurality of states of the dynamic user preference model models temporal changes in declining content preferences of the user over time with respect to the content items consumed by the user;
determine, based on the model, that a current content preference of the user for the content items previously consumed by the user has devalued over time below a threshold;
generate, responsive to the determination, a recommendation of a new one of the content items; and
output the recommendation to the user via the computer network.

13. The non-transitory computer-readable storage medium of claim 12, wherein the instructions cause the computing system to:
update, for each of the users, the model based on a respective frequency of consumption for the content items consumed by the respective user and a time elapsed since a last request for the content items from the user, and
compute, for each of the users, a result indicative of a rate of declining preference for consumption for the content items.

14. The non-transitory computer-readable storage medium of claim 13, wherein the instructions cause the computing system to:
maintain the model to include sensitization and the recurrence preference states for the content items for each of the users, and
represent, within the model, state dependent consumption rates (Cᵢ(t)) for an item i for a user u with the elapsed time for a state sᵢ, given its frequency of consumption f as:
$${C}_{i} ( t \vert {s}_{i} = Sensitization ) = \frac{LL ( t , {α}_{s}^{f} , 1 )}{1 - cLL ( t , {α}_{s}^{f} , 1 )} , and$$
$${C}_{i} ( t \vert {s}_{i} = Recurrence ) = \frac{LL ( t , {α}_{r}^{f} , {β}_{r}^{f} )}{1 - cLL ( t , {α}_{r}^{f} , {β}_{r}^{f} )} .$$

15. The non-transitory computer-readable storage medium of claim 13, wherein the threshold is computed as:
P(sᵢ=Sensitization)<Td and P(sᵢ=Recurrence)<Td→sᵢ=Boredom.
